(19) United States
(12) Patent Application Publication
(10) Pub. No.: US 2026/0093794 A1
(43) Pub. Date: Apr. 2, 2026

(54) INFORMATION PROCESSING APPARATUS, INFORMATION PROCESSING METHOD, INFORMATION PROCESSING SYSTEM, AND NON-TRANSITORY COMPUTER READABLE STORAGE MEDIUM

(71) Applicant: CANON KABUSHIKI KAISHA, Tokyo (JP)

(72) Inventor: TOMOHIRO KAWABE, Tokyo (JP)

(21) Appl. No.: 19/339,541

(22) Filed: Sep. 25, 2025

(30) Foreign Application Priority Data
Sep. 27, 2024 (JP) 2024-169204

(51) Int. Cl. G06F 21/32; G06F 21/60

(52) U.S. Cl. CPC G06F 21/32; G06F 21/604; G06F 2221/2141

(57) ABSTRACT

A biometric information management unit obtains biometric information of a user and sends the biometric information to a service access management unit. The service access management unit determines whether the user has a health anomaly based on the biometric information of the user, and causes a screen display unit to display an access consent request screen for requesting consent to making a reservation for use of the service providing server. Upon obtaining a consent result indicating consent to accessing the service providing server from the screen display unit, the service access management unit sends a request to a credential management unit to obtain authentication credentials required for accessing the service providing server designated in an automatic acquisition target credential table.

### BACKGROUND

### Field of the Technology

The present disclosure relates to an information processing technology for managing highly confidential data.

### Description of the Related Art

There have recently been an increasing number of systems, known as cloud services, for provide software functions via the Internet, and some of them provide functions such as online storage, an accounting system, a learning management system, and online medical treatment. A cloud service provides specific functions to a user by linking a server that provides a service (service providing server) with an information terminal (for example, desktop PC, tablet terminal, wearable device, smartphone, image forming apparatus or the like). Furthermore, there are also an increasing number of cases in which a plurality of cloud services link with each other to provide functions.

In situations of using an information terminal or a cloud service, user authentication is performed using information including a user ID and a password (generally called “credentials”) to prevent unauthorized use and identify a user. The user is requested to input the above information for user authentication in each case where a service providing server and an information terminal link with each other or where cloud services link with each other. This can require cumbersome input operations.

There has recently been proposed a technology for automatically executing predetermined processing in conjunction with a sensor such as a wearable device. U.S. Patent Application Publication No. 2024/0127683 discloses a technology for a wearable device to automatically send a request to a communication device to notify a predetermined contact as the wearable device detects a signal indicating falling of a user.

### SUMMARY

The present disclosure includes: an obtaining unit configured to obtain biometric information of a user; a management unit configured to manage permission to read data stored in a predetermined storage unit and used for the user to use a cloud service, through first authentication processing for authenticating the user based on user input; and a reading unit configured to read the permitted data from the predetermined storage unit, wherein the management unit permits reading of data from the predetermined storage unit without performing the first authentication processing if the biometric information satisfies a predetermined condition.

Features of the present disclosure will become apparent from the following description of Embodiments with reference to the attached drawings. The following description of Embodiments are described by way of example.

### BRIEF DESCRIPTION OF THE DRAWINGS

FIG. 1 is a configuration diagram of an information processing system according to Embodiment 1.

FIG. 2A is a hardware configuration diagram of each apparatus according to Embodiment 1.

FIG. 2B is a hardware configuration diagram of each apparatus according to Embodiment 1.

FIG. 3 is a module configuration diagram of each apparatus according to Embodiment 1.

FIG. 4 is a flowchart for explaining credential selection processing according to Embodiment 1.

FIG. 5A illustrates an example of a credential selection screen according to Embodiment 1.

FIG. 5B illustrates an example of the credential selection screen according to Embodiment 1.

FIG. 6 is a sequence diagram for explaining emergency service access processing according to Embodiment 1.

FIG. 7 is a flowchart of authentication credential acquisition processing according to Embodiment 1.

FIG. 8A is a flowchart for explaining user authentication processing according to Embodiment 1.

FIG. 8B is a flowchart for explaining the user authentication processing according to Embodiment 1.

FIG. 8C is a flowchart for explaining the user authentication processing according to Embodiment 1.

FIG. 8D is a flowchart for explaining the user authentication processing according to Embodiment 1.

FIG. 9 is a flowchart for explaining authorization credential acquisition processing according to Embodiment 1.

FIG. 10A is a flowchart for explaining user authorization processing according to Embodiment 1.

FIG. 10B is a flowchart for explaining the user authorization processing according to Embodiment 1.

FIG. 10C is a flowchart for explaining the user authorization processing according to Embodiment 1.

FIG. 10D is a flowchart for explaining the user authorization processing according to Embodiment 1.

FIG. 11A illustrates an example of an access consent request screen, an authentication result, an authority verification result, and a reservation result displayed on a screen display unit according to Embodiment 1.

FIG. 11B illustrates an example of the access consent request screen, the authentication result, the authority verification result, and the reservation result displayed on the screen display unit according to Embodiment 1.

FIG. 11C illustrates an example of the access consent request screen, the authentication result, the authority verification result, and the reservation result displayed on the screen display unit according to Embodiment 1.

FIG. 11D illustrates an example of the access consent request screen, the authentication result, the authority verification result, and the reservation result displayed on the screen display unit according to Embodiment 1.

FIG. 12 illustrates an example of authentication credentials according to Embodiment 1.

FIG. 13 illustrates an example of authorization credentials according to Embodiment 1.

FIG. 14 illustrates an example of an authorization result issued by an authorization server according to Embodiment 1.

FIG. 15 is a module configuration diagram of each apparatus according to Embodiment 2.

FIG. 16A is a flowchart for explaining user authorization processing according to Embodiment 2.

FIG. 16B is a flowchart for explaining the user authorization processing according to Embodiment 2.

FIG. 16C is a flowchart for explaining the user authorization processing according to Embodiment 2.

FIG. 16D is a flowchart for explaining the user authorization processing according to Embodiment 2.

FIG. 17 is a flowchart for explaining additional credential selection processing according to Embodiment 2.

FIG. 18A illustrates an example of a credential list and consent screen displayed by a screen display unit of an information processing terminal according to Embodiment 2.

FIG. 18B illustrates an example of the credential list and consent screen displayed by the screen display unit of the information processing terminal according to Embodiment 2.

FIG. 19 is a flowchart for explaining additional authorization credential acquisition processing according to Embodiment 2.

FIG. 20 illustrates an example of a request to present a public credential issued by an authorization server according to Embodiment 2.

FIG. 21 illustrates an example of a response to a request to add a credential sent from a service providing server according to Embodiment 2.

FIG. 22 is a module configuration diagram of each apparatus according to Embodiment 3.

FIG. 23 is a flowchart for explaining credential selection processing according to Embodiment 3.

FIG. 24A illustrates an example of a credential list and consent screen displayed by a screen display unit of an information processing terminal according to Embodiment 3.

FIG. 24B illustrates an example of the credential list and consent screen displayed by the screen display unit of the information processing terminal according to Embodiment 3.

FIG. 25 is a flowchart for explaining authorization credential acquisition processing according to Embodiment 3.

FIG. 26 is a configuration diagram of an information processing system according to Embodiment 4.

FIG. 27 is a module configuration diagram of each apparatus according to Embodiment 4.

FIG. 28 is a sequence diagram for explaining emergency service access processing according to Embodiment 4.

FIG. 29A is a flowchart for explaining authentication credential acquisition processing according to Embodiment 4.

FIG. 29B is a flowchart for explaining the authentication credential acquisition processing according to Embodiment 4.

FIG. 30 is a configuration diagram of an information processing system according to Embodiment 5.

FIG. 31 is a module configuration diagram of each apparatus according to Embodiment 5.

FIG. 32 is a sequence diagram for explaining emergency service access processing according to Embodiment 5.

FIG. 33A is a flowchart for explaining authentication credential acquisition processing according to Embodiment 5.

FIG. 33B is a flowchart for explaining the authentication credential acquisition processing according to Embodiment 5.

FIG. 34A is a flowchart for explaining authorization credential acquisition processing according to Embodiment 5.

FIG. 34B is a flowchart for explaining the authorization credential acquisition processing according to Embodiment 5.

FIG. 35A is a flowchart for explaining additional authorization credential acquisition processing according to Embodiment 5.

FIG. 35B is a flowchart for explaining the additional authorization credential acquisition processing according to Embodiment 5.

FIG. 36 is a configuration diagram of an information processing system according to Embodiment 6.

FIG. 37 is a module configuration diagram of each apparatus according to Embodiment 6.

FIG. 38 is a sequence diagram for explaining emergency service access processing according to Embodiment 6.

FIG. 39A is a flowchart for explaining authentication credential acquisition processing according to Embodiment 6.

FIG. 39B is a flowchart for explaining the authentication credential acquisition processing according to Embodiment 6.

FIG. 39C is a flowchart for explaining the authentication credential acquisition processing according to Embodiment 6.

### DESCRIPTION OF THE EMBODIMENTS

Here, consider a case where a user uses a cloud service to make a medical appointment. In making a medical appointment using a cloud service, cumbersome input operations are required to handle personal information protected by authentication processing by the user for user authentication and the like. For this reason, if the user is in very poor physical condition, he/she may not be able to perform input operations to make a medical appointment. Therefore, it is conceivable that, using the technology of U.S. Patent Application Publication No. 2024/0127683, a wearable device or the like makes a medical appointment on behalf of the user, upon detection of an abnormal condition of the user by the wearable device or the like. However, it has heretofore been impossible to read personal information protected by authentication processing by the user, without performing the authentication processing by the user, thus making it impossible for an information terminal to automatically make a medical appointment using the personal information.

The best mode for carrying out the present invention will be described below with reference to the drawings.

### Embodiment 1

In the present embodiment, a method is disclosed wherein, upon detection of a health anomaly of the user, an information processing terminal such as a smartphone automatically obtains personal information managed by the information processing terminal, and automatically requests for a service from a service providing server through an authentication and authorization flow for handling the personal information.

### <System Configuration>

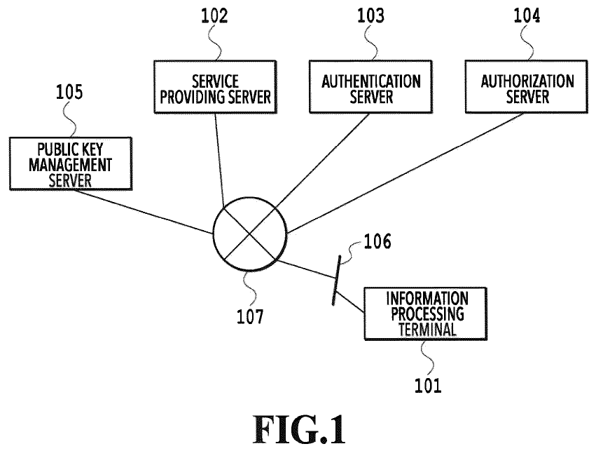

FIG. 1 is a configuration diagram of an information processing system according to an embodiment of the present invention. An information processing terminal 101 is an information processing terminal such as a smartphone, and has a function of requesting a service providing server 102 that provides a cloud service to provide a service. The information processing terminal 101 also has an authentication function and an authorization function for authenticating a user, and is compatible with authentication processing, authorization processing, and the like for the service providing server 102. Authentication is to confirm identification of the user, and authorization is to grant predetermined authority to the user. The information processing terminal 101 also has a function of managing credentials for personal information such as an insurance card, and a function of managing biometric information of the user to detect a health anomaly of the user.

The service providing server 102 is a service providing server, and has a function of providing services upon request from the information processing terminal 101. In the present embodiment, the function provided by the service providing server 102 is a function of making a medical appointment at a medical office. The service providing server 102 also has a function of managing authentication processing with an authentication server 103 in response to an authentication request from the information processing terminal 101, and a function of managing authorization processing with an authorization server 104 in response to an authorization request from the information processing terminal 101.

Upon receipt of the authentication request from the information processing terminal 101 via the service providing server 102, the authentication server 103 sends a challenge code (also simply referred to as a challenge) to the information processing terminal 101 and receives a signed challenge code from the information processing terminal 101. The authentication server 103 also performs signature verification processing based on the signed challenge code received from the information processing terminal 101 via the service providing server 102, and sends a signature verification result to the information processing terminal 101. The signature verification processing is performed based on public key information serving as a public key obtained by sending a request to obtain the public key information to a public key management server I 05. The authentication server 103 is in the same service domain as the service providing server 102, and may be configured to be managed by the same server as the service providing server 102.

Upon receipt of an authorization request from the information processing terminal 101 via the service providing server 102, the authorization server 104 sends a public credential presentation request to the information processing terminal 101 via the service providing server 102. The authorization server 104 also performs authority verification processing based on public credentials (VP), which are credentials received from the information processing terminal 101 and intended for disclosing personal information to a service, via the service providing server 102. The public credential is an authorization credential obtained by extracting only the information required for authority verification from a credential. The authorization server 104 sends the authority verification result to the information processing terminal 101 via the service providing server 102. Also, in a case of verifying the public credentials, the authorization server 104 sends a request to obtain public key information to the public key management server 105, and verifies a signature based on the obtained public key information. The authorization server 104 is in the same service domain as the service providing server 102, and may be configured to be managed by the same server as the service providing server 102.

The public key management server 105 manages the public key information linked to a sender and an issuer of the credentials of the information processing terminal 101 or the like. Furthermore, upon receipt of the public key information acquisition requests from the authentication server 103 and the authorization server 104, the public key management server 105 obtains public key information corresponding to an identifier (such as a DID which will be described later) included in the public key information acquisition requests, and sends the obtained public key information to the authentication server 103 and the authorization server 104.

The information processing terminal 101 is connected to a global network 107 via a local network 106. The service providing server 102, the authentication server 103, the authorization server 104, and the public key management server 105 are connected via the global network 107. A local network 106 is realized by a LAN or the like. The global network 107 is a communication network realized by any one of a WAN, a telephone line, a dedicated digital line, an ATM or frame relay line, a cable TV line, a data broadcasting wireless line, and the like, or a combination thereof.

### <Hardware Configuration>

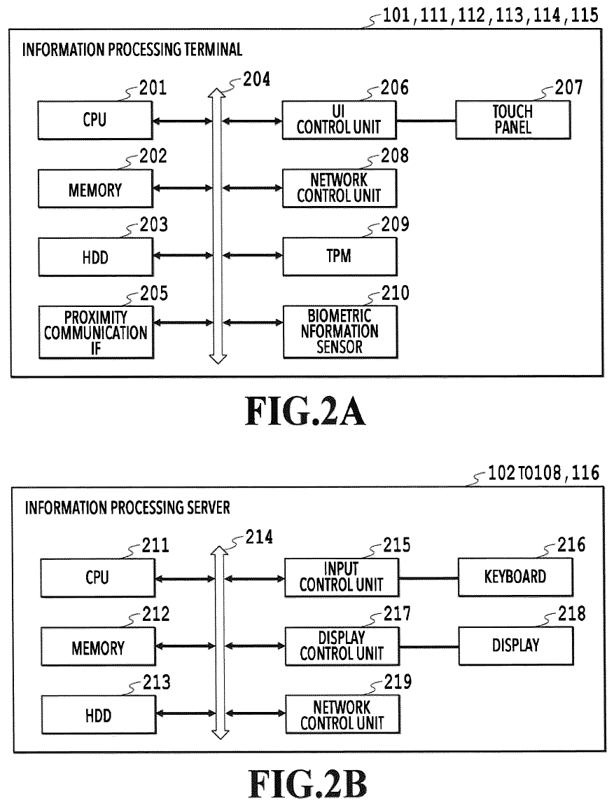

FIG. 2A is a block diagram illustrating an example of a hardware configuration of an information processing terminal constituting the information processing terminal 101. FIG. 2B is a block diagram illustrating an example of a hardware configuration of an information processing server constituting the service providing server 102, the authentication server 103, the authorization server 104, and the public key management server 105.

The information processing terminal 101 includes a CPU 201 configured to execute software stored in a hard disk drive (HDD) 203, which is a storage unit. The CPU 201 performs overall control of each piece of hardware connected to a system bus 204.

A memory 202 functions as a main memory, a work area, and the like for the CPU 201. The HDD 203 stores data as a large-capacity storage unit. A UI control unit 206 controls input from an input device 207 such as a touch panel, for example. A network control unit 208 exchanges data bidirectionally with other nodes via a network. A proximity communication IF 205 is a network I/F for proximity communication such as NFC or BlueTooth, and communicates with other information processing apparatuses and authentication terminals to exchange data. A TPM 209 is a tamper-resistant storage device that protects stored data from being read from outside for the purpose of processing and holding confidential information, and stores biometric information used in authentication, or credentials such as a private key corresponding to the biometric information. In the present embodiment, the TPM 209 is a storage device built into the information processing terminal 101, but may be replaced by a cloud storage with desired tamper-resistance. A biometric information sensor 210 is a sensor for observing the biometric information of the user, for example, a fingerprint, vein, voiceprint, iris, facial image, body temperature, and heart rate of the user, and converts such information into a digital signal. The biometric information sensor 210 is realized using a dedicated observation device such as a fingerprint sensor, or a general-purpose device such as a camera or microphone capable of observing the biometric information.

The information processing server includes a CPU 211 configured to execute software stored in a hard disk drive (HDD) 213, which is a storage unit. The CPU 211 controls each piece of hardware connected to a system bus 214. A memory 212 functions as a main memory, a work area, and the like for the CPU 211. The HDD 213 stores data as a large-capacity storage unit. An input control unit 215 controls input from an input device 216 such as a keyboard, for example. Depending on the role of the information processing apparatus, the configuration does not have to include the input control unit 215 and the input device 216. A display control unit 217 controls display on a display device 218 such as a liquid crystal display, for example. Depending on the role of the information processing apparatus, the configuration does not have to include the display control unit 217 and the display device 218. A network control unit 219 exchanges data bidirectionally with other nodes via a network.

The information processing server may be realized by an information processing apparatus provided as a cloud computing service. Cloud computing includes serverless computing, virtual machines, and the like. In cloud computing, a plurality of hardware configurations illustrated in FIG. 2B are used. The service providing server 102, the authentication server 103, the authorization server 104, and the public key management server 105 may each be realized by one information processing server.

### <Function Framework>

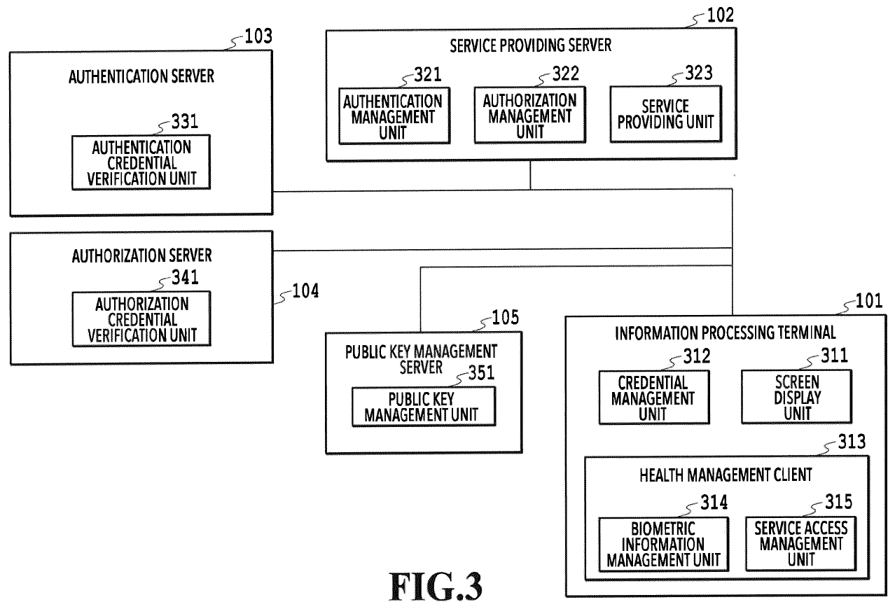

FIG. 3 is a block diagram illustrating an example of a function framework of the information processing terminal 101, the service providing server 102, the authentication server 103, the authorization server 104, and the public key management server 105.

The information processing terminal 101 includes a screen display unit 311, a credential management unit 312, and a health management client 313. The screen display unit 311 has a function of interpreting HTML, XML, and the like, and displaying a screen. In the present embodiment, the screen display unit 311 displays the screen by receiving a screen display request from a service access management unit 315 of the health management client 313. The credential management unit 312 has a function of managing credentials representing personal information held by the user. In the present embodiment, the credentials for authentication are referred to as authentication credentials, and the credentials for authorization are referred to as authorization credentials. In the present embodiment, the data format of the authentication credentials conforms to DID (Decentralized Identifier), and the data format of the authorization credentials conforms to VC (Verifiable Credentials). However, the authentication credentials and the authorization credentials may be credentials in different formats for handling personal information. Also, the service access management unit 315 of the health management client 313 can be configured with automatic acquisition settings to receive a request from a user experiencing a health anomaly and to obtain credentials. The service access management unit 315 also sends public credentials. The public credentials conform to VP (Verifiable Presentation) specifications, and only attribute information required by the authorization server out of the authorization credentials (VC) can be sent. However, in the present embodiment, all information contained in the authorization credentials (VC) is disclosed and sent to the authorization server.

Table 1 is an example of an authentication credential management table, which is a table managed by the credential management unit 312 to manage the authentication credentials. The authentication credentials shown in Table 1 include at least an authentication credential identifier, a credential path, a private key, and a client automatic acquisition flag. The authentication credential identifier is an identifier of an authentication credential. The credential path is a path of actual data of the authentication credential. The private key is a private key used upon authentication. The client automatic acquisition flag indicates whether the service access management unit 315 of the health management client 313 can automatically obtain credentials. If the client automatic acquisition flag is “TRUE”, it is indicated that the service access management unit 315 can automatically obtain credentials. If the client automatic acquisition flag is “FALSE”, it is indicated that the service access management unit 315 cannot automatically obtain credentials.

TABLE 1

| Authentication | | | |
|---|---|---|---|
| credential | | | Client automatic |
| identifier | Credential path | Private key | acquisition flag |
| C00001 | /did/credentialpath1 | aaaaaaaa-bbbb- | FALSE |
| | | cccc-dddd- | |
| | | eeeeeeeeeeee | |

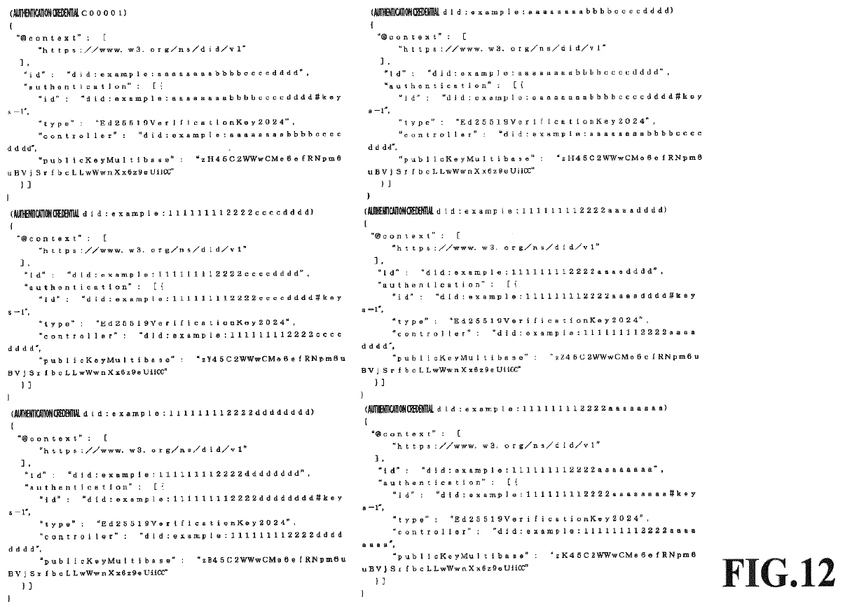

FIG. 12 illustrates an example of an authentication credential (C00001) in the present embodiment. In the authentication credential, “@context” indicates the format of the authentication credential to be used, “id” indicates the identifier of the authentication credential, and “authentication” indicates the format of a public key.

Table 2 is an example of an authorization credential management table, which is a table managed by the credential management unit 312 to manage the authorization credentials. The authorization credentials illustrated in Table 2 each include at least an authorization credential identifier that is an identifier of the authorization credential, a credential path indicating a path of actual data of the authorization credential, and a client automatic acquisition flag.

TABLE 2

| Authorization | | Client automatic |
|---|---|---|
| credential identifier | Credential path | acquisition flag |
| V00001 | /vc/credentialpath1 | FALSE |
| V00002 | /vc/credentialpath2 | FALSE |
| V00003 | /vc/credentialpath3 | FALSE |
| V00004 | /vc/credentialpath4 | FALSE |

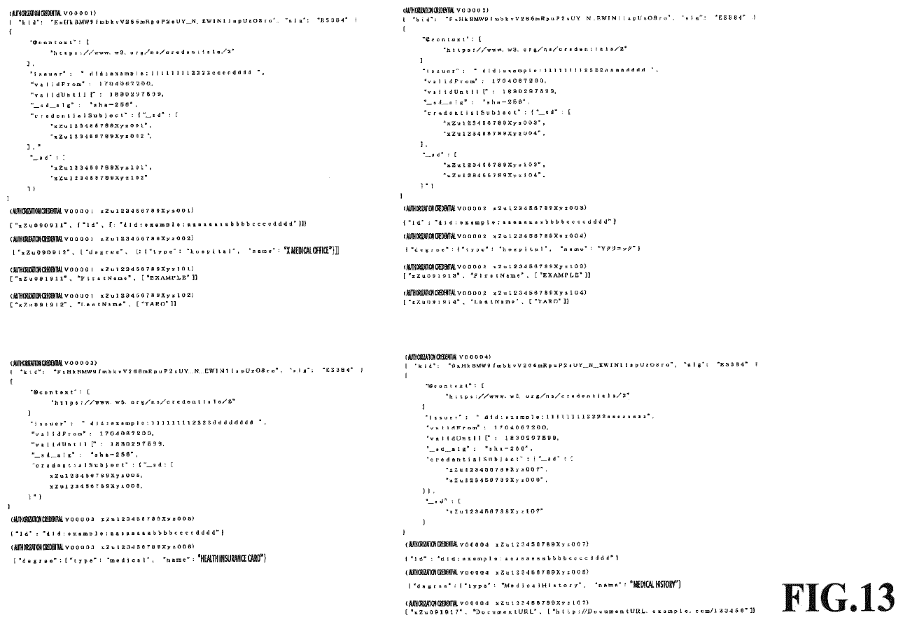

FIG. 13 illustrates an example of authorization credentials (V00001 to V00004). “_sd” in the authorization credential is serialized personal information. In the present embodiment, the serialization format complies with the SD-JWT (Selective-Disclosure Json Web Token) specifications. SD-JWT is a publicly known technology published in draft-ietf-oauth-selective-disclosure-jwt-10, and thus detailed description thereof will be omitted. Also, “issuer” in the authorization credential indicates the issuer of the authorization credential. “validFrom” indicates the date and time of issuance of the authorization credential. “validUntil” indicates the expiration date of the authorization credential. “@context” indicates the format of the authorization credential. “credentialSubject” indicates the information of the issued authorization credential. “_sd_alg” indicates the encryption format of the personal information.

The health management client 313 includes a biometric information management unit 314 and a service access management unit 315. The biometric information management unit 314 manages biometric information. The biometric information management unit 314 collects biometric information obtained from the user, and sends alarm information to the service access management unit 315, if the value of the collected biometric information exceeds a threshold value, as a message notifying that the threshold value has been exceeded. An example of the alarm information sent to the service access management unit 315 by the biometric information management unit 314 in the present embodiment will be described below. The alarm information includes at least a category indicating the type of biometric information whose value exceeds the threshold value and an observation value indicating the collected value. In the present embodiment, the format of the alarm information is JSON (JavaScript Object Notation), but other data formats may be used.

### (Example of Alarm Information)

{“Category”: “Core body temperature”, “Observation value”: 39.5}

Table 3 is an example of a threshold information table managed by the biometric information management unit 314 to manage the threshold value of biometric information. The threshold information has at least a threshold value that is a threshold value for each piece of biometric information to be obtained, and a category indicating the type of biometric information.

TABLE 3

| Threshold value | Category |
|---|---|
| 37.5 | Core body temperature |
| 130 | Pulse |

The service access management unit 315 cooperates with the service providing server 102. Upon receipt of a message indicating that the threshold value has been exceeded from the biometric information management unit 314, the service access management unit 315 sends a service use request to the service providing server 102. The service access management unit 315 can also send a request to obtain authentication credentials and authorization credentials to the credential management unit 312, and obtain the authentication credentials and authorization credentials from the credential management unit 312. The service access management unit 315 sends an authentication request and an authorization request to the service providing server 102, based on the obtained authentication credentials and authorization credentials. Furthermore, upon receipt of the threshold exceeded message notified from the biometric information management unit 314, the service access management unit 315 selects the authentication credential and authorization credential to be obtained from the credential management unit 312 and performs automatic acquisition setting operation. Table 4 is an example of an automatic acquisition target credential table, which is a table for managing the credentials to be obtained. The credentials to be obtained each include at least a credential identifier for identifying the credential and a credential type. Furthermore, the service access management unit 315 has an authentication credential acquisition flag, which is a flag indicating whether the authentication credential acquisition has been successful. If the authentication credential acquisition flag is “TRUE”, it is indicated that the credential acquisition has been successful. If the authentication credential acquisition flag is “FALSE”, it is indicated that the authentication credential acquisition has failed. In addition, the service access management unit 315 has an authentication success flag, which is a flag indicating that the authentication has been successful. If the authentication success flag is “TRUE”, it is indicated that the authentication has been successful. If the authentication success flag is “FALSE”, it is indicated that the authentication has failed.

TABLE 4

| | |
|---|---|
| Credential identifier | Type |

The service providing server 102 has an authentication management unit 321, an authorization management unit 322, and a service providing unit 323. The authentication management unit 321 sends an authentication request to the authentication server 103, based on an authentication request from the information processing terminal 101. The authentication management unit 321 also sends a challenge code sent from the authentication server 103 to the information processing terminal 101. The authorization management unit 322 sends an authorization request to the authorization server 104, based on an authorization request from the information processing terminal 101. The authentication management unit 321 also sends a request to present the public credentials sent from the authorization server 104 to the information processing terminal 101. The service providing unit 323 performs reservation processing based on a service use request sent from the information processing terminal 101, and sends the reservation result to the information processing terminal 101. Table 5 is an example of a reservation information table managed by the service providing unit 323 of the service providing server 102. The reservation information table includes at least an available reservation date and time indicating available date and time of reservation, and a reserved flag indicating whether or not a reservation has been made. If the reserved flag is “TRUE”, it is indicated that a reservation has been made for the applicable date and time. If the reserved flag is “FALSE”, it is indicated that a reservation can be made for the applicable date and time.

TABLE 5

| Available reservation date and time | Reserved flag |
|---|---|
| 10:00 | FALSE |

The authentication server 103 includes an authentication credential verification unit 331. The authentication credential verification unit 331 creates a challenge code based on the authentication request sent from the service providing server 102, and sends the created challenge code to the service providing server 102. The authentication credential verification unit 331 also performs authentication processing based on the authentication credential and signature sent from the service providing server 102, and sends the authentication result to the service providing server 102. In addition, the authentication credential verification unit 331 sends a request to obtain public key information corresponding to the public key management server 105 based on the authentication credential, and verifies the signature based on the obtained public key information.

The authorization server 104 includes an authorization credential verification unit 341. The authorization credential verification unit 341 creates a request to present public credentials based on the authorization request sent from the service providing server 102, and sends the request to the service providing server 102. The authorization credential verification unit 341 also performs authority verification processing based on the public credentials sent from the service providing server 102, and sends the verification result to the service providing server 102. In addition, the authorization credential verification unit 341 sends a request to obtain public key information corresponding to the public key management server 105 based on the public credential, and verifies whether the public credential is valid based on the obtained public key information. Furthermore, if the public credential is valid, the authorization credential verification unit 341 performs authority verification processing based on the public credential.

The public key management server 105 includes a public key management unit 351. Upon receipt of a request to obtain public key information requested by the authentication server 103 and the authorization server 104, the public key management unit 351 sends the requested public key information. Table 6 is an example of a public key management information table managed by the public key management unit 351. The public key management information includes at least a public key ID for identifying a public key and a credential path, which is a path of actual data of the public key. In the present embodiment, the public key ID is the DID of the credential holder and the DID of the credential issuer.

TABLE 6

| Public key ID | Credential path |
|---|---|
| did:example: aaaaaaaabbbbccccdddd | /did/credential path1 |
| did:example: 111111112222ccccdddd | /did/credential path2 |
| did:example: 111111112222aaaadddd | /did/credential path3 |
| did:example: 111111112222dddddddd | /did/credential path4 |
| did:example: 111111112222aaaaaaaa | /did/credential path5 |

FIG. 12 illustrates an example of the authentication credentials linked to each public key ID managed under each credential path in the present embodiment. The data structure of the authentication credentials in the present Embodiment Is the same as the authentication credentials in the credential management unit 312 of the information processing terminal 101.

### <Credential Selection Processing>

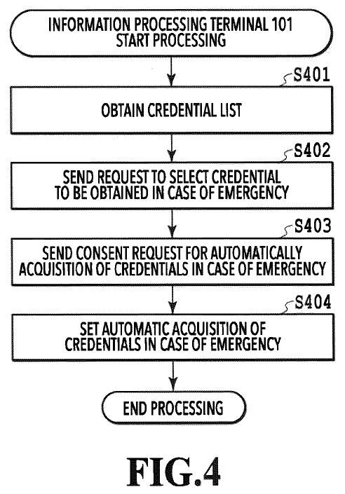

FIG. 4 is a flowchart for explaining credential selection processing executed in the information processing terminal 101 according to the present embodiment. In order to automatically obtain credentials linked to the user of the information processing terminal 101, it is necessary to verify whether the credentials can be obtained. In this processing, a setting to automatically obtain the credentials of the user who uses the information processing terminal 101 is executed only in a case where an abnormality of the user is detected based on his/her biometric information.

In S401, the service access management unit 315 obtains a credential list from the credential management unit 312 of the information processing terminal 101.

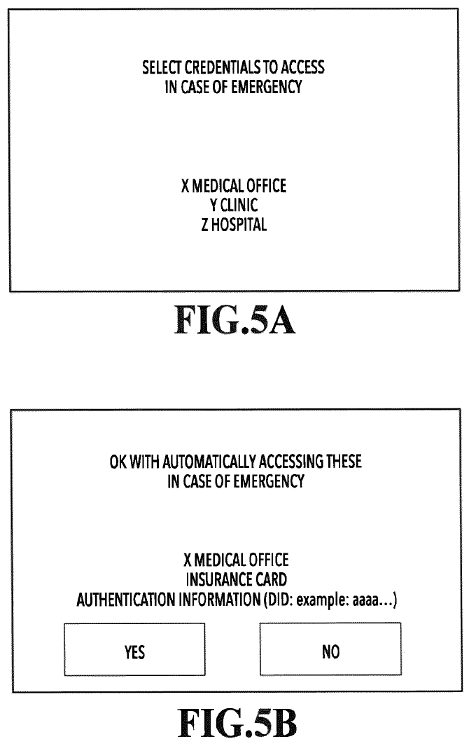

In S402, the service access management unit 315 sends a request to select credentials to be automatically obtained in case of emergency based on user input. Based on the credential list obtained in S401, the service access management unit 315 sends a credential list display request to the screen display unit 311 of the information processing terminal 101. Upon receipt of the credential list display request, the screen display unit 311 displays the credential list. FIG. 5A illustrates an example of the credential list displayed by the screen display unit 311 of the information processing terminal 101 in the present embodiment. In the present embodiment, only the authorization credentials whose “type” is “hospital” among the authorization credentials illustrated in FIG. 13 are displayed. Based on the credential selection made by the user on the screen display unit 311 of the information processing terminal 101, the service access management unit 315 determines the credential to be obtained in case of emergency.

In S403, the service access management unit 315 sends a consent request for the credential to be obtained in case of emergency. The service access management unit 315 identifies the authentication credential (C00001 in the present embodiment) linked to the authorization credential from the obtained credential list, based on the DID included in the “issuer” of the credential received from the user. Next, the service access management unit 315 identifies the authorization credentials whose “type” is “medical”. Based on the identified credential list, the service access management unit 315 sends a request to display a consent request screen to the screen display unit 311, and receives input from the user. FIG. 5B illustrates an example of a consent screen displayed on the screen display unit 311 according to the present embodiment.

In S404, the service access management unit 315 sets up a setting to automatically obtain the credentials to be obtained in case of emergency. The screen display unit 311 of the information processing terminal 101 receives input from the user and sends a consent result to the service access management unit 315. Upon receipt of the consent result from the screen display unit 311, the service access management unit 315 sends a request to the credential management unit 312 to update the client automatic acquisition flag of the credential, for which consent to automatic acquisition has been obtained, to “TRUE”. In addition, the service access management unit 315 registers the credential to be automatically obtained and ends this processing. Table 7 is an example of an updated authentication credential management table managed by the credential management unit 312. Table 8 is an example of an updated authorization credential management table managed by the credential management unit 312. Table 9 is an example of an updated automatic acquisition target credential table managed by the service access management unit 315.

TABLE 7

| | | | Client |
|---|---|---|---|
| Authentication | | | automatic |
| credential | | | acquisition |
| identifier | Credential path | Private key | flag |
| C00001 | /did/credentialpath1 | aaaaaaaa-bbbb-cccc- | TRUE |
| | | dddd-eeeeeeeeeeee | |

TABLE 8

| Authorization | | Client automatic |
|---|---|---|
| credential identifier | Credential path | acquisition flag |
| V00001 | /vc/credential path1 | TRUE |
| V00002 | /vc/credentialpath2 | FALSE |
| V00003 | /vc/credentialpath3 | TRUE |
| V00004 | /vc/credentialpath4 | FALSE |

TABLE 9

| Credential identifier | Type |
|---|---|
| C00001 | Authentication credential |
| V00001 | Authorization credential |
| V00003 | Authorization credential |

### <Emergency Service Access Processing>

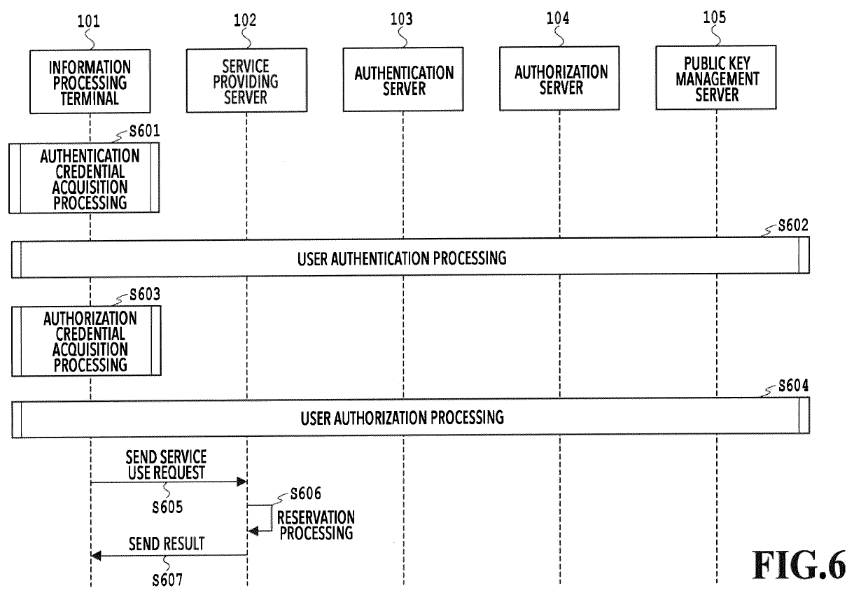

FIG. 6 is a sequence chart explaining emergency service access processing according to the present embodiment. In this processing, the information processing terminal 101 sends a service use request to the service providing server 102 upon detection of a health anomaly of the user based on his/her biometric information.

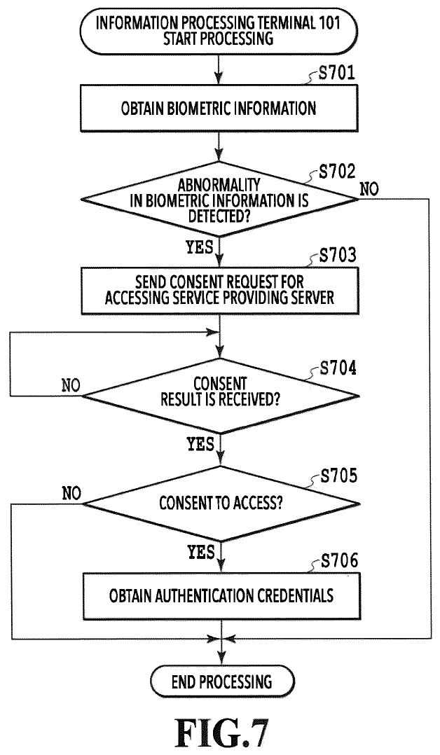

In S601, the information processing terminal 101 performs authentication credential acquisition processing. The authentication credential acquisition processing will be described in detail later with reference to FIG. 7.

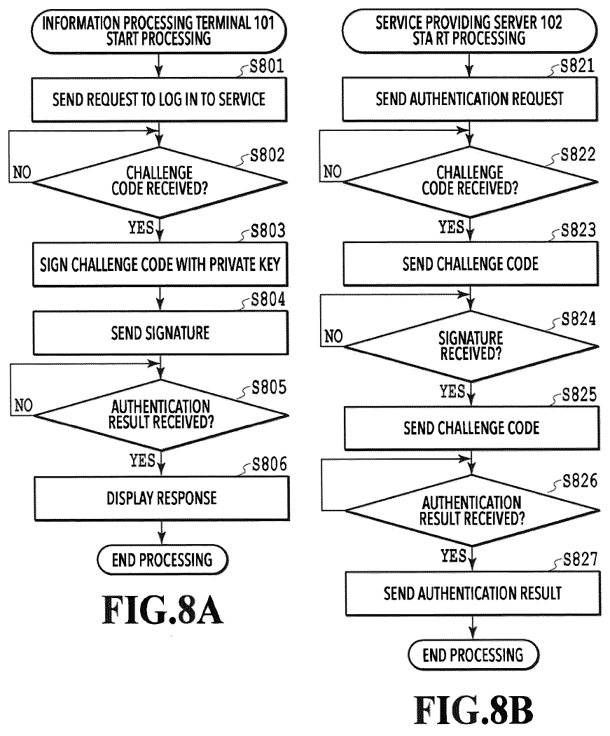

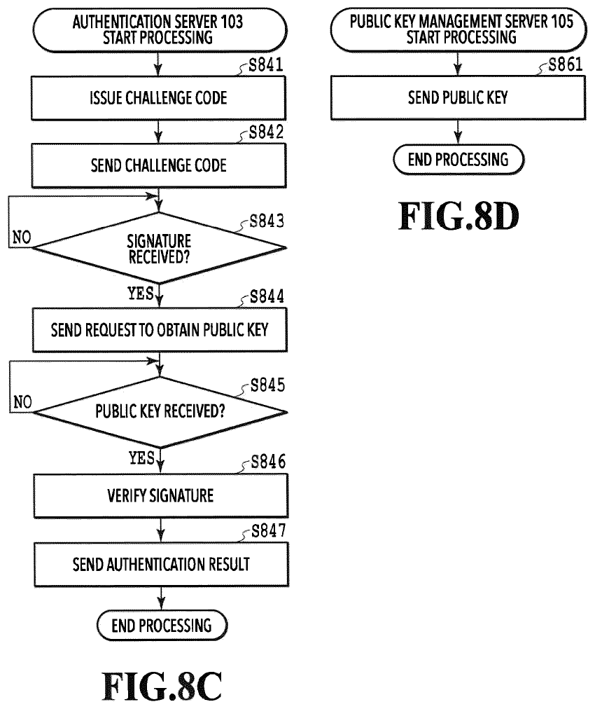

In S602, the information processing terminal 101, the service providing server 102, the authentication server 103, and the public key management server 105 perform user authentication processing. The user authentication processing will be described in detail later with reference to FIGS. 8A to 8D.

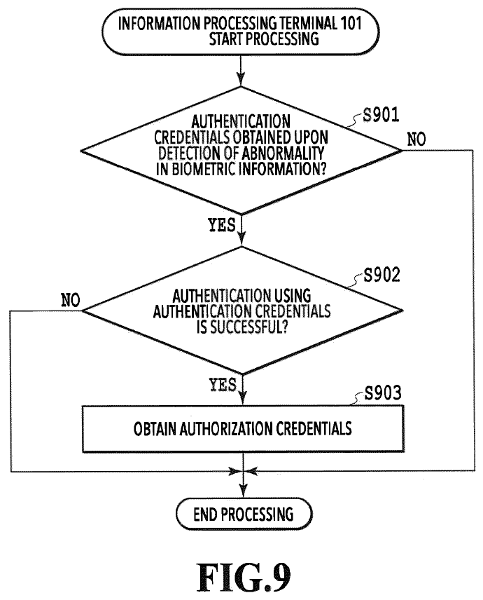

In S603, the information processing terminal 101 performs authorization credential acquisition processing. The authorization credential acquisition processing will be described in detail later with reference to FIG. 9.

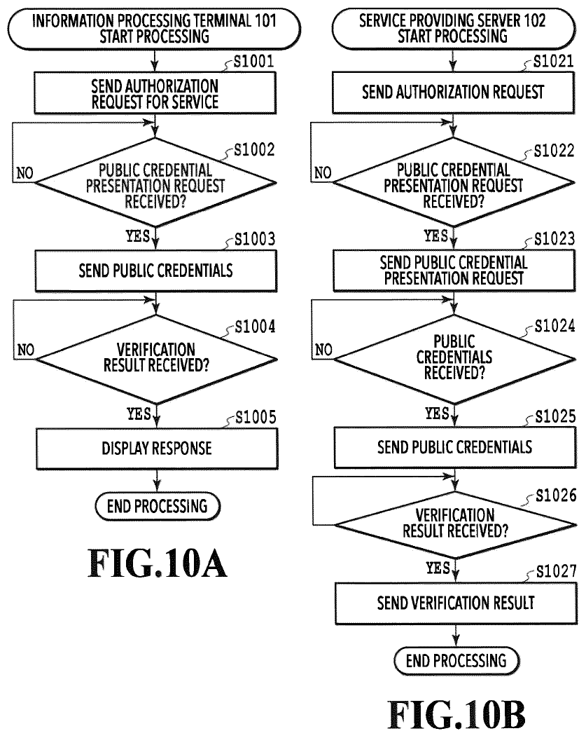

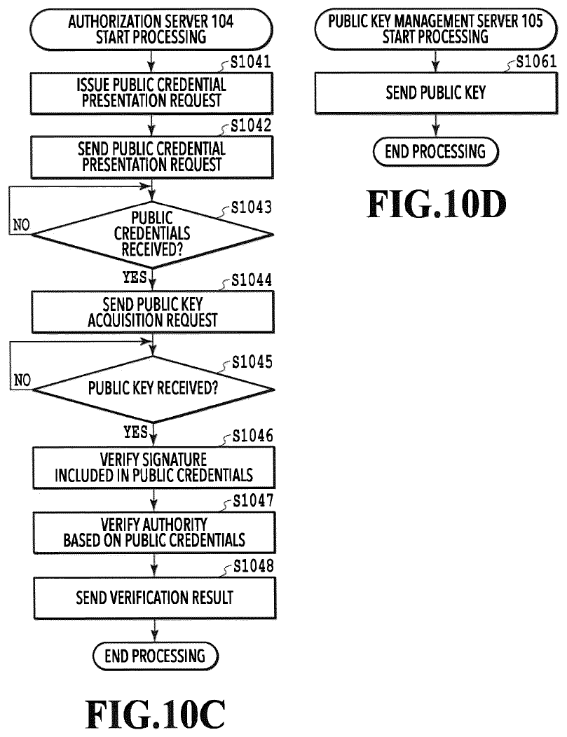

In S604, the information processing terminal 101, the service providing server 102, the authorization server 104, and the public key management server 105 perform user authorization processing. The user authorization processing will be described in detail later with reference to FIG. 10.

In S605, the service access management unit 315 of the information processing terminal 101 sends a service use request from the user to the service providing server 102.

In S606, the service providing server 102 performs service use reservation processing, based on the user authentication result and authorization result linked to the service use request. The service providing unit 323 of the service providing server 102 searches through a reservation information table to obtain one piece of the reservation information whose reserved flag is “FALSE”, and sets the reserved flag to “TRUE” as shown in Table 10.

TABLE 10

| Available reservation date and time | Reserved flag |
|---|---|
| 10:00 | TRUE |

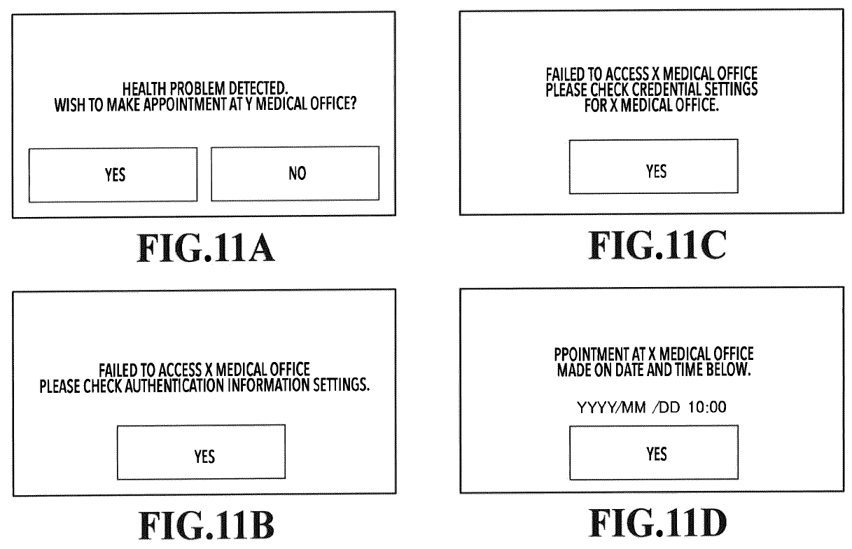

In S607, the service providing unit 323 of the service providing server 102 sends the reservation result to the information processing terminal 101. The service access management unit 315 of the information processing terminal 101 sends a request to display the reservation result to the screen display unit 311. The screen display unit 311 then displays the reservation result and ends this processing. FIG. 11D illustrates an example of the reservation result displayed on the screen display unit 311 of the information processing terminal 101 in the present embodiment.

### <Authentication Credential Acquisition Processing (S601)>

FIG. 7 is a flowchart explaining the authentication credential acquisition processing according to the present embodiment. In this processing, the information processing terminal 101 determines whether to automatically obtain authentication credentials, by acquiring biometric information of the user who uses the information processing terminal 101.

In S701, the biometric information management unit 314 obtains the biometric information of the user, which is the core body temperature in the present embodiment, and sends the biometric information to the service access management unit 315.

In S702, the service access management unit 315 determines whether the user has a health anomaly, based on the biometric information of the user. In the present embodiment, whether the user has a health anomaly is determined by whether the observed value of the biometric information meets a predetermined condition, such as whether the core body temperature is equal to or higher than a predetermined threshold value. If a health anomaly is detected, the processing proceeds to S703, and if not, the processing returns to S701.

In S703, the service access management unit 315 causes the screen display unit 311 to display an access consent request screen for requesting consent to make a reservation for use of the service providing server 102. The biometric information management unit 314 sends an alarm message indicating a health anomaly to the service access management unit 315. Upon receipt of the alarm message, the service access management unit 315 sends a request to the screen display unit 311 to display the access consent request screen to the service providing server 102, and causes the screen display unit 311 to display the access consent request screen. FIG. 11A illustrates an example of an access consent request displayed by the screen display unit 311 of the information processing terminal 101 in the present embodiment.

In S704, the service access management unit 315 obtains the consent result from the screen display unit 311. Upon receipt of an input from the user in response to the access consent request, the screen display unit 311 sends the input result to the service access management unit 315. If the service access management unit 315 obtains the input result sent from the screen display unit 311, the processing proceeds to S705, and if not, the service access management unit 315 repeatedly executes S704 at predetermined intervals until the input result is obtained from the screen display unit 311.

In S705, the service access management unit 315 determines whether the input result indicates consent to access to the service providing server 102. If the input result indicates consent to access to the service providing server 102, the processing proceeds to S706, and if not, this processing ends.

In S706, the service access management unit 315 sends a request to the credential management unit 312 to obtain the authentication credentials required to access the service providing server 102 designated in the automatic acquisition target credential table (Table 9). The credential management unit 312 sends the authentication credentials requested to be obtained to the service access management unit 315. In addition, the service access management unit 315 sets the authentication credential acquisition flag of the authentication credentials requested to be obtained to “TRUE”, and ends this processing.

### <User Authentication Processing (S602)>

FIGS. 8A to 8D are flowcharts for explaining the user authentication processing according to the present embodiment. This processing is user authentication processing carried out by the information processing terminal 101, the service providing server 102, the authentication server 103, and the public key management server 105, based on the automatically obtained authentication credentials.

FIG. 8A is a flowchart for explaining the user authentication processing performed by the information processing terminal 101.

In S801, the service access management unit 315 sends an authentication request based on the DID of the user to the service providing server 102.

In S802, the service access management unit 315 determines whether a challenge code is received from the service providing server 102. If the challenge code is obtained, the processing proceeds to S804, and if not, S802 is repeatedly executed at predetermined intervals until a challenge code is received.

In S803, the service access management unit 315 sends a signature request to the credential management unit 312. The credential management unit 312 signs the received challenge code with a private key and sends the signature to the service access management unit 315.

In S804, the service access management unit 315 sends the signed challenge code to the service providing server 102.

In S805, the service access management unit 315 determines whether an authentication result is received from the service providing server 102. If the authentication result is received, the processing proceeds to S808, and if not, S805 is repeatedly executed at predetermined intervals until the authentication result is received.

In S806, the service access management unit 315 sends a request to the screen display unit 311 to display an authentication result screen, based on the received authentication result. If the authentication processing is successful, the service access management unit 315 sets the authentication success flag in the automatic acquisition target credential table to “TRUE”, and ends this processing. Note that in the present embodiment, if the user authentication is successful, the screen is not displayed, and if the authentication has failed, the authentication result is displayed and this processing ends. FIG. 11B illustrates an example of the authentication result display screen displayed on the screen display unit 311 in the present embodiment.

FIG. 8B is a flowchart for explaining the user authentication processing performed by the service providing server 102.

In S821, upon receipt of an authentication request from the information processing terminal 101, the authentication management unit 321 sends the authentication request to the authentication server 103.

In S822, the authentication management unit 321 determines whether a challenge code is received from the authentication server 103. If the challenge code is received, the processing proceeds to S823, and if not, S822 is repeatedly executed at predetermined intervals until a challenge code is received.

In S823, the authentication management unit 321 sends the received challenge code to the information processing terminal 101.

In S824, the authentication management unit 321 determines whether a signed challenge code is received from the information processing terminal 101. If the signed challenge code is received, the processing proceeds to S825, and if not, S824 is repeatedly executed at predetermined intervals until a signed challenge code is received.

In S825, the authentication management unit 321 sends the signed challenge code to the authentication server 103.

In S826, the authentication management unit 321 determines whether an authentication result is received from the authentication server 103. If the authentication result is received, the processing proceeds to S827, and if not, S826 is repeatedly executed at predetermined intervals until an authentication result is received.

In S827, the authentication management unit 321 sends the authentication result to the information processing terminal 101 and ends this processing.

FIG. 8C is a flowchart for explaining the user authentication processing performed by the authentication server 103.

In S841, upon receipt of an authentication request from the service providing server 102, the authentication credential verification unit 331 issues a challenge code.

In S842, the authentication credential verification unit 331 sends the issued challenge code to the service providing server 102.

In S843, the authentication credential verification unit 331 determines whether a signed challenge code is received from the service providing server 102. If the signed challenge code is received, the processing proceeds to S844, and if not, S843 is repeatedly executed at predetermined intervals until a signed challenge code is received.

In S844, the authentication credential verification unit 331 sends a request to the public key management server 105 to obtain public key information, based on the DIDs of the holder and issuer of the authentication credential included in the authentication request received in S841.

In S845, the authentication credential verification unit 331 determines whether public key information is received from the public key management server 105. If the public key information is received, the processing proceeds to S846, and if not, S845 is repeatedly executed at predetermined intervals until public key information is received.

In S846, the authentication credential verification unit 331 verifies the signature obtained in S823, based on the public key information obtained in S845.

In S847, the authentication credential verification unit 331 performs authentication processing based on the signature verification result, and sends the authentication result to the service providing server 102 before ending this processing.

FIG. 8D is a flowchart for explaining the user authentication processing performed by the public key management server 105.

In S861, upon receipt of a request to obtain public key information from the authentication server 103, the public key management unit 351 sends public key information corresponding to the DID included in the request to obtain public key information to the authentication server 103, and ends this processing. In the present embodiment, the public key management unit 351 sends public key information whose public key ID is “did:example:aaaaaaaabbbbccccdddd” in the public key management information table managed by the public key management unit 351.

### <Authorization Credential Acquisition Processing (S603)>

FIG. 9 is a flowchart for explaining the authorization credential acquisition processing according to the present embodiment. In this processing, the information processing terminal 101 determines whether to obtain authorization credentials, by acquiring biometric information of the user who uses the information processing terminal 101.

In S901, the service access management unit 315 determines whether authentication credentials are obtained upon detection of an abnormality in the biometric information. If the authentication credential acquisition flag is checked to be “TRUE”, the processing proceeds to S902, and if not, this processing ends.

In S902, the service access management unit 31s′verifies whether the authentication using the obtained authentication credentials is successful in the user authentication processing. If the authentication success flag is checked to be “TRUE”, the processing proceeds to S903, and if not, this processing ends.

In S903, the service access management unit 315 sends a request to the credential management unit 312 to obtain all of the authorization credentials designated in the automatic acquisition target credential table. The credential management unit 312 sends the public credentials in a batch to the service access management unit 315. In addition, the service access management unit 315 sets the authorization credential acquisition flag, which is a flag indicating that the authorization credential has been successfully obtained, to “TRUE”, and ends this processing.

### <User Authorization Processing (S604)>

FIGS. 10A to 10D are flowcharts for explaining the user authorization processing according to the present embodiment. In this processing, the information processing terminal 101, the service providing server 102, the authorization server 104, and the public key management server 105 perform authentication processing, based on the automatically obtained authorization credentials.

FIG. 10A is a flowchart for explaining the user authorization processing performed by the information processing terminal 101.

In S1001, the service access management unit 315 sends an authorization request to the service providing server 102.

In S1002, the service access management unit 315 determines whether a request to present public credentials is received from the service providing server 102. If the request to present public credentials is obtained, the processing proceeds to S1003, and if not, S1002 is repeatedly executed at predetermined intervals until a request to present public credentials is received.

In S1003, the service access management unit 315 sends the public credentials to the service providing server 102.

In S1004, the service access management unit 315 determines whether a verification result on the public credentials is received from the service providing server 102. If the verification result is obtained, the processing proceeds to S1005, and if not, S1004 is repeatedly executed at predetermined intervals until the verification result is received.

In S1005, the service access management unit 315 sends a request to the screen display unit 311 to display an authority verification result screen, based on the received verification result of the public credentials. If the authority verification processing is successful, the service access management unit 315 sets the authority verification success flag, which is a flag indicating successful acquisition, to “TRUE”, and ends this processing. In the present embodiment, no screen is displayed if the authority verification processing is successful. If the authority verification processing has failed, the authority verification result is displayed, and this processing ends. FIG. 11C illustrates an example of the authority verification result displayed on the screen display unit 311 in the present embodiment.

FIG. 10B is a flowchart for explaining the user authorization processing performed by the service providing server 102.

In S1021, upon receipt of an authorization request from the information processing terminal 101, the authorization management unit 322 sends the authorization request to the authorization server 104.

In S1022, the authorization management unit 322 determines whether a request to present public credentials is received from the authorization server 104. If the request to present public credentials is received, the processing proceeds to S1023, and if not, S1022 is repeatedly executed at predetermined intervals until a request to present public credentials is received.

In S1023, the authorization management unit 322 sends the request to present public credentials to the information processing terminal 101.

In S1024, the authorization management unit 322 determines whether public credentials are received from the information processing terminal 101. If the public credentials are received, the processing proceeds to S1025, and if not, S1024 is repeatedly executed at predetermined intervals until the public credentials are received.

In S1025, the authorization management unit 322 sends a signature to the authorization server 104.

In S1026, the authorization management unit 322 determines whether an authentication result is obtained from the authorization server 104. If the authentication result is obtained, the processing proceeds to S1027, and if not, S1026 is repeatedly executed at predetermined intervals until the authentication result is obtained.

In S1027, the authorization management unit 322 sends the authorization result to the information processing terminal 101, and ends this processing.

FIG. 10C is a flowchart for explaining the user authorization processing performed by the authorization server 104.

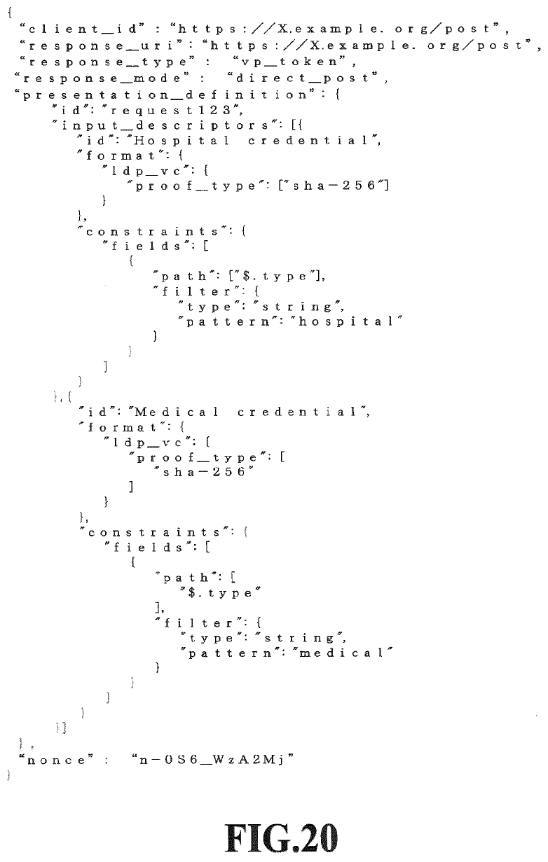

In S1041, upon receipt of an authorization request from the service providing server 102, the authorization credential verification unit 341 issues a request to present public credentials. FIG. 20 illustrates an example of the request to present public credentials issued by the authorization server 104. In this example, “client_id” and “response_url” indicate the endpoint of the presentation request destination, that is, the service providing server 102. “response_type” indicates the format of the presentation request made to the information processing terminal 101. “presentation_definition” indicates the format of the requested authorization credentials. In the case of the request illustrated in FIG. 20, authorization credentials whose “type” is “hospital” and “medical” are requested, among the authorization credentials illustrated in FIG. 13.

In S1042, the authorization credential verification unit 341 transmits a request to the service providing server 102 to present the issued public credential.

In S1043, the authorization credential verification unit 341 determines whether a public credential is from the service providing server 102. If the public credential is received, the processing proceeds to S1044, and if not, S1043 is repeatedly executed at predetermined intervals until a public credential is received.

In S1044, the authorization credential verification unit 341 sends a request to the public key management server 105 to obtain public key information based on the DIDs of the holder and issuer of the authorization credential included in the authorization request received in S1041.

In S1045, the authorization credential verification unit 341 determines whether public key information is received from the public key management server 105. If the public key information is received, the processing proceeds to S1046, and if not, S1045 is repeatedly executed until the public key information is received.

In S1046, the authorization credential verification unit 341 verifies the signature of the public credential based on the public key information.

In S1047, the authorization credential verification unit 341 verifies the obtained public credential. In the present embodiment, it is verified whether the public credential whose “name” is “X medical office” and the public credential whose “name” is “health insurance card” are included. If those public credentials are included, the verification is determined as successful, and if not, the verification is determined as failed.

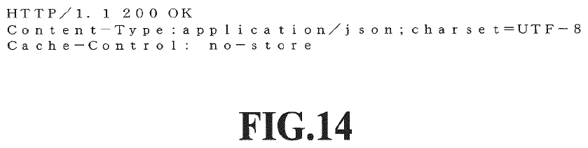

In S1048, the authorization credential verification unit 341 sends the verification result and ends this processing. FIG. 14 illustrates an example of the authorization result issued by the authorization server 104. In the present embodiment, if the verification is successful, only a HTTP status code is returned, but the configuration may be such that an authorization token for accessing the service providing server 102 is issued and added to the response body to be returned.

FIG. 10D is a flowchart for explaining the user authorization process performed by the public key management server 105.

In S1061, upon receipt of a request to obtain public key information from the authorization server 104, the public key management unit 351 sends the public key information to the authorization server 104 and ends this processing. In the present embodiment, public key information of the public key ID that matches the DID of the issuer of the authorization credentials whose “type” is “hospital” and “medical” in the public key management information table managed by the public key management unit 351 is sent in a batch. In the public key management information table illustrated in Table 6 and the authorization credentials illustrated in FIG. 13, the public key IDs of the public key information transmitted in a batch in the present embodiment are the following three.

(Embodiment 2)

| | | |
|---|---|---|
| | - | “did:example: :1111111112222ccccddddd” |
| - | | “did:example: 111111112222aaaaddddd” |
| - | | “did:example: 1111111112222dddddddddd” |

In using a service, there are cases where additional personal information is required. A specific example is a case where, in order to receive detailed medical treatment at a hospital, it is required to present a medical history in addition to health insurance card and patient registration card. The present embodiment discloses a method for automatically executing an additional authorization flow in a case where additional personal information is required upon request from the service side during the authorization processing using the method disclosed in Embodiment 1.

### <System Configuration>

A system configuration of the present Embodiment Is the same as that of Embodiment 1, and thus description thereof will be omitted.

### <Hardware Configuration>

A hardware configuration of the present Embodiment Is the same as that of Embodiment 1, and thus description thereof will be omitted.

### <Module Configuration>

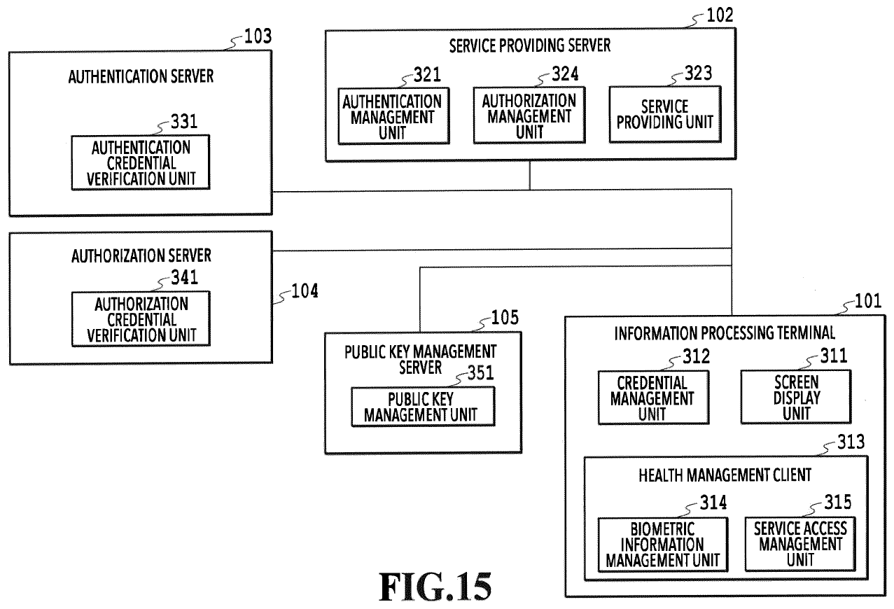

FIG. 15 is a module configuration diagram of each apparatus according to Embodiment 2.

Since a screen display unit 311, a credential management unit 312, and a biometric information management unit 314 of a health management client 313 in an information processing terminal 101 are the same as those in Embodiment 1, description thereof will be omitted. A service access management unit 316 has a function of sending an authorization credential requested to be added in response to a request to add the authorization credential from the authorization server 104, in addition to the function of the service access management unit 315 in Embodiment 1. The service access management unit 316 also has a function of setting to send an additional public credential upon receipt of the request to add the authorization credential from the authorization server 104. Table 11 is an example of a table of credentials to be added, which is managed by the service access management unit 316 of the information processing terminal 101. The credential to be added has at least a credential identifier indicating the identifier of a credential, a type indicating the type of the credential, and a name which is the name of the credential.

TABLE 11

| | | |
|---|---|---|
| Credential identifier | Type | Name |

An authentication management unit 321 and a service providing unit 323 in a service providing server 102 are the same as those in Embodiment 1, and thus description thereof will be omitted. An authorization management unit 324 has a function of receiving a request to present an additional public credential from the authorization server 104 and sending the received request to present the additional public credential to the information processing terminal 101, in addition to the function of the authorization management unit 322 in Embodiment 1. In addition, the authorization management unit 324 receives the additional public credential sent from the information processing terminal 101, and sends the received additional public credential to the authorization server 104.

An authentication server 103 has the same configuration as that in Embodiment 1, and thus description thereof will be omitted.

An authorization credential verification unit 342 of the authorization server 104 has a function of sending a request to add an authorization credential, in addition to the function of the authorization credential verification unit 341 in Embodiment 1. In addition, upon receipt of an additional authorization credential from the service providing server 102, the authorization credential verification unit 342 verifies the additional authorization credential and sends the verification result to the service providing server 102. Furthermore, the authorization credential verification unit 342 has a function of determining whether the user who accessed the service has presented data required to use the service. Table 12 is an example of a requisite presentation information table, which is a table managed by the authorization credential verification unit 342 to manage information required to use the service. The requisite presentation information includes at least a user identifier for uniquely identifying the user and a type of requisite information. In the present embodiment, the user is uniquely identified by his/her name, but the service may issue an identifier for uniquely identifying the user and use the identifier as the user identifier. In the present embodiment, the data required to use the service is a public credential “MedicalHistory”.

TABLE 12

| User Identifier | Type |
|---|---|
| JIRO EXAMPLE | MedicalHistory |

### <Credential Selection Processing>

This processing is the same as in Embodiment 1, and thus description thereof will be omitted.

### <Additional Credential Selection Processing>

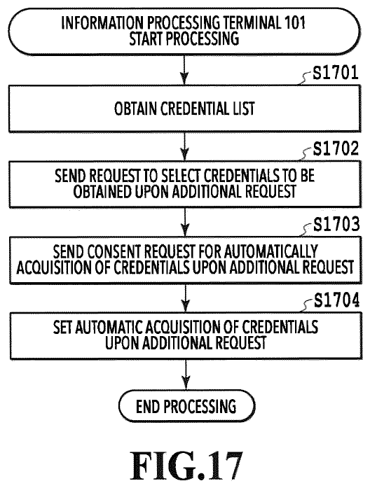

FIG. 17 is a flowchart for explaining additional credential selection processing according to the present embodiment. This processing is executed by the information processing terminal 101 upon receipt of a request to add an authorization credential.

In S1701, the service access management unit 316 of the information processing terminal 101 sends a request to the credential management unit 312 of the information processing terminal 101 to obtain credentials in a batch.

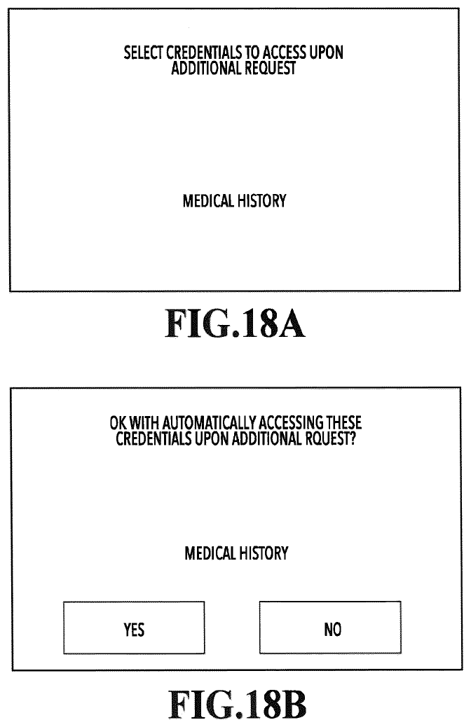

In S1702, the service access management unit 316 of the information processing terminal 101 sends a request to select credentials to be obtained upon request to add from the authorization server 104. Based on the credential list obtained in S1701, the service access management unit 316 sends a credential list display request to the screen display unit 311 of the information processing terminal 101. Upon receipt of the credential list display request, the screen display unit 311 displays the credential list. FIG. 18A is an example of the credential list displayed by the screen display unit 311 of the information processing terminal 101 in the present embodiment. In the present embodiment, only authorization credentials whose “type” is “MedicalHistory” and whose “id” is linked to the authentication credential obtained in case of emergency (C00001 in the present embodiment) are displayed. Based on the user's credential selection received by the screen display unit 311 of the information processing terminal 101, the service access management unit 316 determines the credential to be obtained in case of emergency.

In S1703, the service access management unit 316 of the information processing terminal 101 sends a consent request for the credentials to be obtained upon request for addition. The service access management unit 316 sends a request to the screen display unit 311 to display a consent request screen, and receives input from the user. FIG. 18B illustrates an example of a consent screen displayed on the screen display unit 311.

In S1704, the service access management unit 316 of the information processing terminal 101 sets up a setting to automatically obtain the credentials to be additionally obtained upon request. The screen display unit of the information processing terminal 101 receives input from the user and sends the consent result to the service access management unit 316. Upon receipt of the consent result from the screen display unit 311, the service access management unit 316 sends a request to the credential management unit 312 to update the client automatic acquisition flag of the corresponding credential to “TRUE”. In addition, the service access management unit 316 registers the credentials to be automatically obtained and ends this processing. Table 13 is an example of an updated authorization credential management table managed by the credential management unit 312 of the information processing terminal 101. Table 14 is an example of an updated table of credentials to be additionally obtained, which is managed by the service access management unit 316 of the information processing terminal 101.

TABLE 13

| Authorization | | Client automatic |
|---|---|---|
| credential identifier | Credential path | acquisition flag |
| V00001 | /vc/credentialpath1 | TRUE |
| V00002 | /vc/credentialpath2 | FALSE |
| V00003 | /vc/credentialpath3 | TRUE |
| V00004 | /vc/credentialpath4 | TRUE |

TABLE 14

| Credential identifier | Type | Name |
|---|---|---|
| V00004 | Authorization credential | MedicalHistory |

### <Emergency Service Access Processing>

This processing is the same as in Embodiment 1, and thus description thereof will be omitted.

### <Authentication Credential Acquisition Processing>

This processing is the same as in Embodiment 1, and thus description thereof will be omitted.

### <User Authentication Processing>

This processing is the same as in Embodiment 1, and thus description thereof will be omitted.

### <Authorization Credential Acquisition Processing>

This processing is the same as in Embodiment 1, and thus description thereof will be omitted.

### <User Authorization Processing>

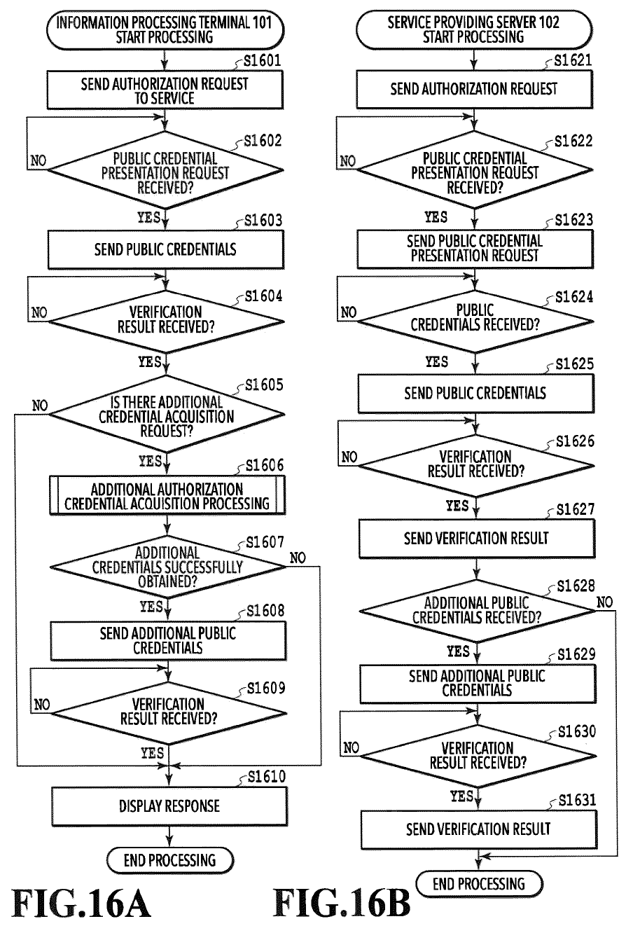

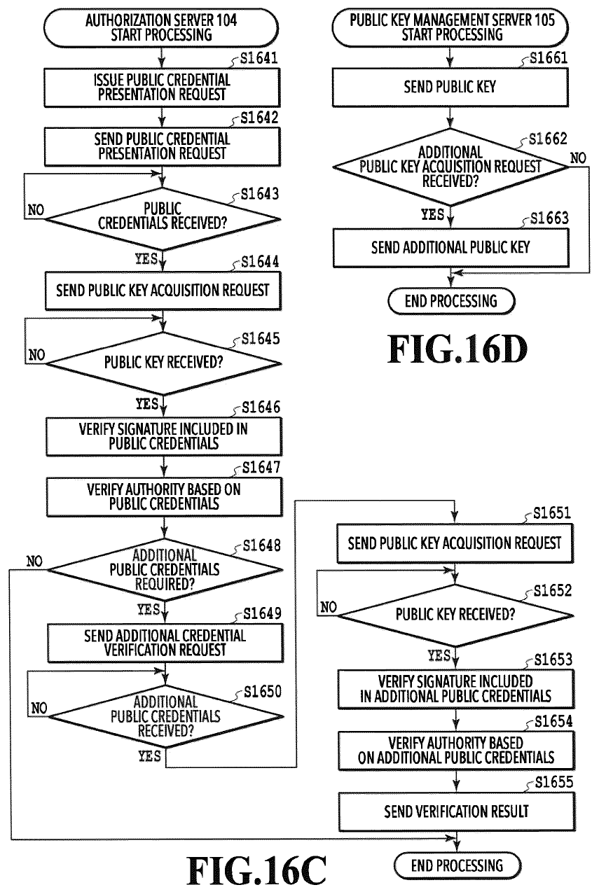

FIGS. 16A to 16D are flowcharts for explaining user authorization processing according to the present embodiment. In this processing, the information processing terminal 101 sends additional public credentials in response to a request to add authorization credentials from the authorization server 104, in addition to the same user authorization processing as in Embodiment 1.

FIG. 16A is a flowchart for explaining the user authorization processing performed by the information processing terminal 101. S1601 to S1604 are the same as S1001 to S1004 in Embodiment 1, and thus description thereof will be omitted.

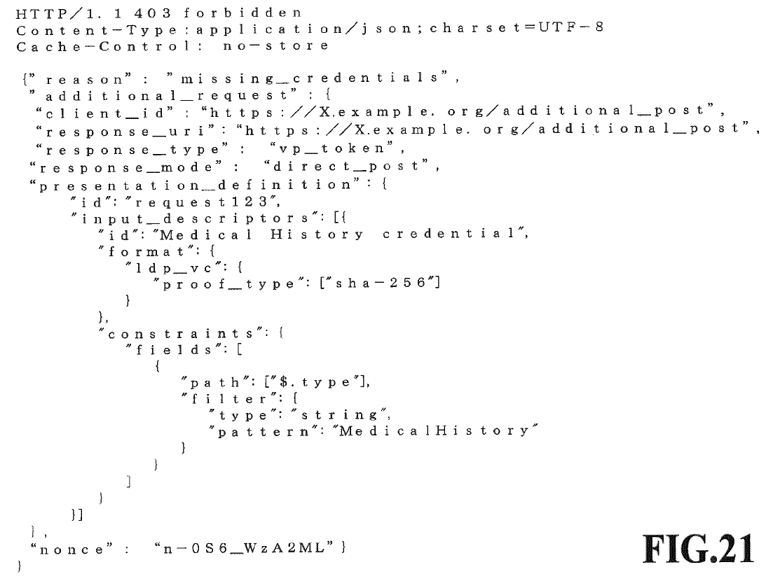

In S1605, the service access management unit 316 determines whether a response received from the service providing server 102 is a credential addition request. If the response is the credential addition request, the processing proceeds to S1606, and if not, the processing proceeds to S1610. FIG. 21 illustrates an example of the credential addition request sent from the service providing server 102. The example illustrated in FIG. 21 is an addition request because “reason” is “missing_credentials” and “additional _request” is included. The format of the addition request is the same as the public credential presentation request in FIG. 20. In the example illustrated in FIG. 21, the authorization credential whose “type” is “MedicalHistory” is requested to be added, among the authorization credentials illustrated in FIG. 13.

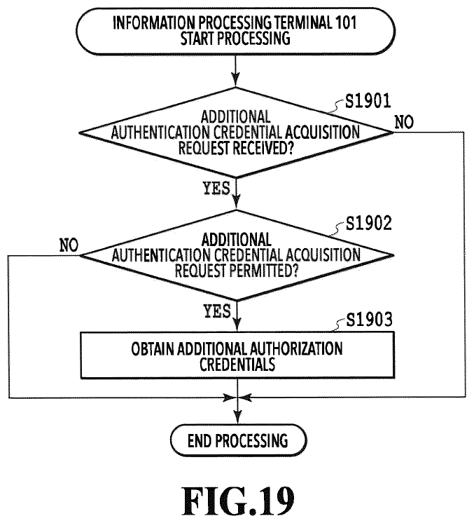

In S1606, the service access management unit 316 executes authorization credential additional acquisition processing. The authorization credential additional acquisition processing will be described in detail later with reference to FIG. 19.

In S1607, the service access management unit 316 determines whether an additional authorization credential is obtained. If the additional authorization credential is obtained, the processing proceeds to S1608, and if not, the processing proceeds to S1610.

In S1608, the service access management unit 316 sends the obtained additional authorization credential to the service providing server 102. The service access management unit 316 accesses an API provided by the service providing server 102, which is designated by the URL of “response_url” included in the response to the credential addition request sent from the service providing server 102. The service access management unit 316 then sends the requested additional authorization credential to the accessed APL

In S1609, the service access management unit 316 determines whether an authorization result based on the verification result of the additional public credentials is received from the service providing server 102. If the authorization result is received, the processing proceeds to S1610, and if not, S1609 is repeated until the authorization result is received.

S1610 is the same as S1008 in Embodiment 1, and thus description thereof will be omitted.

FIG. 16B is a flowchart for explaining the user authorization processing performed by the service providing server 102. S1621 to S1627 are the same as S1021 to S1027 in Embodiment 1, and thus description thereof will be omitted.

In S1628, the authorization management unit 324 determines whether an additional public credential is received from the information processing terminal 101. If the additional public credential is received, the processing proceeds to S1629, and if not, this processing ends.

In S1629, the authorization management unit 324 sends the received additional public credential to the authorization server 104.

In S1630, the authorization management unit 324 determines whether an authorization result for the authorization request based on the verification result of the additional public credential is received from the authorization server 104. If the authorization result is received, the processing proceeds to S1631, and if not, S1630 is repeatedly executed at predetermined intervals until the authorization result is received.

In S1631, the authorization management unit 324 sends the received authorization result to the information processing terminal 101, and ends this processing.

FIG. 16C is a flowchart for explaining the user authorization processing performed by the authorization server 104. S1641 to S1647 are the same as S1041 to S1047 in Embodiment 1, and thus description thereof will be omitted.

In S1648, the authorization credential verification unit 342 determines whether additional public credentials are required. In the present embodiment, it is determined whether the public credentials include a medical history. First, the authorization credential verification unit 342 obtains “FirstName” and “LastName” included in the public credentials sent from the information processing terminal 101, and creates a user identifier, which is “TARO_EXAMPLE” in the present embodiment. Next, the authorization credential verification unit 342 checks whether there is a credential which corresponds to the user identifier created in the requisite presentation information table and whose type (“name” in the example illustrated in FIG. 13) is “medical history”. If there is such a credential, this processing ends, and if not, the processing proceeds to S1649.

In S1649, the authorization credential verification unit 342 sends a public credential addition request to the service providing server 102. The public credential addition request sent by the authorization credential verification unit 342 here is the same as that illustrated in FIG. 21.

In S1650, the authorization credential verification unit 342 determines whether additional public credentials are received from the service providing server 102. If the additional public credentials are received, the processing proceeds to S1651, and if not, S1650 is repeatedly executed at predetermined intervals until the additional public credentials are obtained.

In S1651, the authorization credential verification unit 342 sends a request to the public key management server 105 to obtain public key information based on the issuer DID included in the additional public credentials.

In S1652, the authorization credential verification unit 342 determines whether the public key information is obtained from the public key management server 105. If the public key information is obtained, the processing proceeds to S1653, and if not, S1652 is repeatedly executed at predetermined intervals until the public key information is obtained.

In S1653, the authorization credential verification unit 342 verifies the signature of the received additional public credential based on the public key information.

In S1654, the authorization credential verification unit 342 verifies the additional public credentials. In the present embodiment, it is verified whether the additional public credentials include a credential whose “name” is “medical history”. If such a credential is included, the verification is determined as successful, and if not, the verification is determined as failed.

In S1655, the authorization credential verification unit 342 issues an authorization result for the authorization request based on the verification result of the additional public credentials, and sends the authorization result to the service providing server 102 before ending this processing. The format of the authorization result issued here is the same as in FIG. 14.

FIG. 16D is a flowchart for explaining the user authorization processing performed by the public key management server 105. S1661 is the same as S1061 in Embodiment 1, and thus description thereof will be omitted.

In S1662, the public key management unit 351 determines whether a public key information addition request is received from the authorization server 104. If the request is received, the processing proceeds to S1663, and if not, this processing ends.

In S1663, the public key management unit 351 sends public key information to the authorization server 104 in response to the public key information addition request received from the authorization server 104, and ends this processing. In the present embodiment, public key information whose public key ID 1s “did:example::11111111122222aaaaaaaa” in the public key management information table managed by the public key management unit 351 is sent in a batch.

### <Authorization Credential Additional Acquisition Processing (S1606)>

FIG. 19 is a flowchart for explaining the authorization credential additional acquisition processing according to the present embodiment. In this processing, the information processing terminal 101 additionally obtains public credentials in response to an authorization credential addition request from the authorization server 104.

In S1901, the service access management unit 316 determines whether an authorization credential addition request is received. If the request is obtained, the processing proceeds to S1902, and if not, this processing ends.

In S1902, the service access management unit 316 checks whether acquisition of credentials requested to be added is permitted. The service access management unit 316 refers to the table of credentials to be added, which is managed by the service access management unit 316, and obtains the credential linked to the name (“MedicalHistory” in the present embodiment) of the credential requested to be added by the authorization server 104. If the credential is successfully obtained, the processing proceeds to S1903, and if not, this processing ends.

In S1903, the service access management unit 316 sends a request to the credential management unit 312 to obtain an additional credential corresponding to the credential identifier. In response to the request, the credential management unit 312 sends the public credential of “V00004” and ends this processing.

### Embodiment 3

There are cases where the user wishes to automatically change the services to be used, depending on his/her situation. Specifically, there is a case where the user wishes to change the hospital to visit, depending on the symptoms of poor physical condition. The present embodiment discloses a method for changing the authorization credentials to be obtained, depending on the symptoms of poor physical condition of the user, using the method disclosed in Embodiment 2.

### <System Configuration>

A system configuration of the present Embodiment Is the same as that of Embodiment 2, and thus description thereof will be omitted.

### <Hardware Configuration>

A hardware configuration of the present Embodiment Is the same as that of Embodiment 2, and thus description thereof will be omitted.

### <Module Configuration>

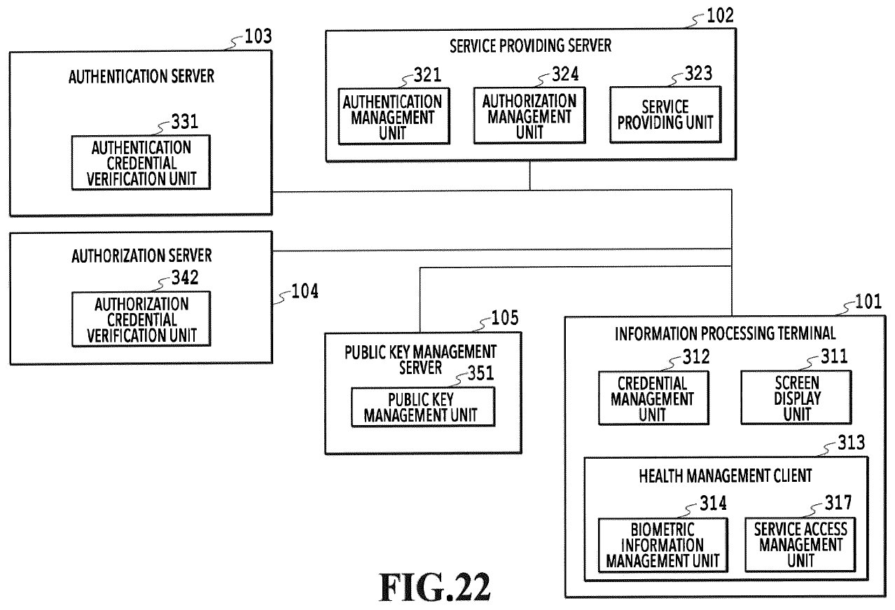

FIG. 22 is a module configuration diagram of each apparatus according to Embodiment 3.

Since a screen display unit 311, a credential management unit 312, and a biometric information management unit 314 of a health management client 313 in an information processing terminal 101 are the same as those in Embodiment 2, description thereof will be omitted. A service access management unit 317 has a function of changing credentials to be obtained for each type of biometric information included in alarm information, in addition to the function of either one of the service access management units 315 and 316 of Embodiments 1 and 2. Table 15 is an example of a table of credentials to be automatically obtained, which is managed by the service access management unit 317. The credentials to be automatically obtained include the credential identifier and credential type in Embodiment 2, as well as a biometric information type, which is the type of biometric information included in the alarm information.

The service access management unit 317 also has an authorization credential acquisition flag, which is a flag indicating whether the authorization credential acquisition has been successful. If the authorization credential acquisition flag is “TRUE”, it is indicated that the authorization credential acquisition has been successful. If the authorization credential acquisition flag is “FALSE”, it is indicated that the authorization credential acquisition has failed. In the present embodiment, the biometric information type is set only once for each biometric information type, but the configuration may be such that the biometric information type can be set more than once, and the setting of the biometric information type may be changeable. The setting frequency of the credentials for each biometric information type is managed by the credential setting flag for each biometric information type, in the present embodiment, by the core body temperature setting flag. If the core body temperature setting flag is “TRUE”, it is indicated that the setting frequency has already been set. If the core body temperature setting flag is “FALSE”, it is indicated that the setting frequency is yet to be set.

TABLE 15

| | | |
|---|---|---|
| Credential identifier | Type | Biometric information type |

Function frameworks of a service providing server 102, an authentication server 103, an authorization server 104, and a public key management server 105 are the same as those of Embodiments 1 and 2, and thus description thereof will be omitted.

### <Credential Selection Processing>

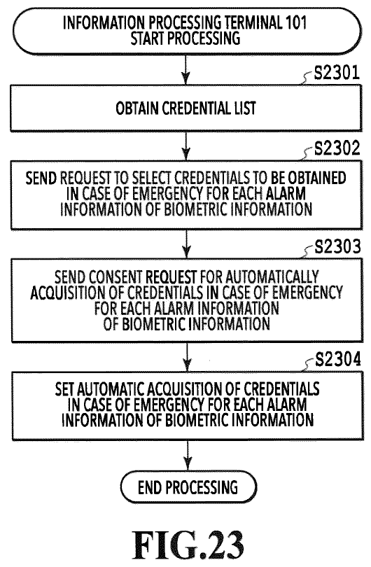

FIG. 23 is a flowchart for explaining credential selection processing according to the present embodiment. In this processing, as in Embodiments 1 and 2, a setting to automatically obtain the credentials of the user who uses the information processing terminal 101 is executed only in a case where an abnormality of the user is detected based on his/her biometric information. In this case, in the present embodiment, the credential to be automatically obtained is changed according to the type of biometric information for which the abnormality is detected.

S2301 is the same as S401 in Embodiment 1, and thus description thereof will be omitted.

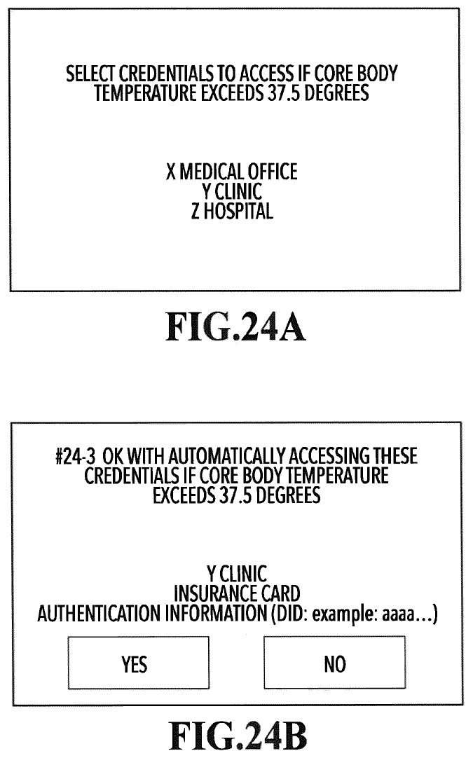

In S2302, the service access management unit 317 of the information processing terminal 101 sends a request to select a credential to be obtained in case of emergency, for each alarm information of the biometric information. Based on a credential list obtained in S2301, the service access management unit 317 sends a credential list display request to the screen display unit 311 of the information processing terminal 101. Upon receipt of the credential list display request, the screen display unit 311 displays the credential list. FIG. 24A illustrates an example of the credential list displayed by the screen display unit 311 of the information processing terminal 101 in the present embodiment. In the present embodiment, as in the example illustrated in FIG. 13, only the authorization credentials whose “type” is “hospital” are displayed. Based on the user's credential selection received by the screen display unit 311 of the information processing terminal 101, the service access management unit 317 determines the credential to be obtained in case of emergency (“V00002” in the present embodiment).

In S2303, the service access management unit 317 of the information processing terminal 101 sends a consent request for the credential to be obtained in case of emergency for each alarm information of the biometric information. The service access management unit 317 identifies the authentication credential (C00001) linked to the authorization credential, from the obtained credential list, based on the “issuer” of the credential to be obtained in case of emergency (V00002) received from the user. Subsequently, the service access management unit 317 identifies the authorization credentials whose “type” is “medical”. Based on a list of the identified credentials, the service access management unit 317 sends a request to the screen display unit 311 to display a consent request screen, and receives input from the user. FIG. 24B illustrates an example of a consent screen displayed on the screen display unit 311.

In S2304, the service access management unit 317 of the information processing terminal 101 sets up a setting to automatically obtain credentials to be obtained in case of emergency. The screen display unit of the information processing terminal 101 receives input from the user, and sends a consent result to the service access management unit 317. Upon receipt of the consent result from the screen display unit 311, the service access management unit 317 sends a request to the credential management unit 312 to update the client automatic acquisition flag of the credential, for which consent to automatic acquisition has been obtained, to “TRUE”. The service access management unit 317 also sets the core body temperature setting flag to “TRUE”, and registers the credential to be automatically obtained before ending this processing. The updated authentication credential management table and authorization credential management table managed by the credential management unit 312 of the information processing terminal 101 are the same as Tables 7 and 8 in Embodiment 2. Table 16 is an example of the updated table of credentials to be automatically obtained, which is managed by the service access management unit 317 of the information processing terminal 101.

TABLE 16

| Credential | | Biometric |
|---|---|---|
| identifier | Type | information type |
| C00001 | Authentication credential | Core body temperature |
| V00002 | Authorization credential | Core body temperature |
| V00003 | Authorization credential | Core body temperature |

### <Additional Credential Selection Processing>

This processing is the same as in Embodiments 1 and 2, and thus description thereof will be omitted.

### <Emergency Service Access Processing>

This processing is the same as in Embodiments 1 and 2, and thus description thereof will be omitted.

### <Authentication Credential Acquisition Processing>

This processing is the same as in Embodiments 1 and 2, and thus description thereof will be omitted.

### <User Authentication Processing>

This processing is the same as in Embodiments 1 and 2, and thus description thereof will be omitted.

### <Authorization Credential Acquisition Processing>

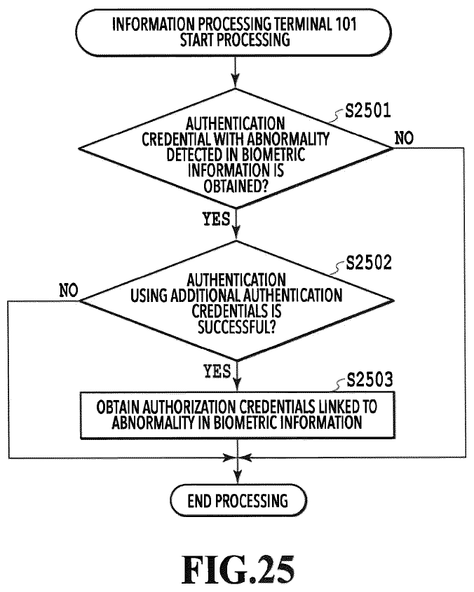

FIG. 25 is a flowchart for explaining authorization credential acquisition processing according to Embodiment 3. The present embodiment has a function of acquiring credentials according to alarm information, in addition to the function of Embodiment 2. FIG. 25 is a flowchart illustrating processing performed by the information processing terminal 101 in the authorization credential acquisition processing.

S2501 to S2502 are the same as S901 to S902 in Embodiment 2, and thus description thereof will be omitted.

In S2503, the service access management unit 317 of the information processing terminal 101 sends a request to the credential management unit 312 to obtain authorization credentials in a batch, which are designated in the automatic acquisition target credential table (Table 16) in response to the alarm information. In the present embodiment, the biometric information used in the alarm information is “core body temperature”. The credential management unit 312 sends public credentials linked to the alarm in a batch to the service access management unit 317. In addition, the service access management unit 317 sets the authorization credential acquisition flag to “TRUE”, and ends this processing.

### <User Authorization Processing>

This processing is the same as in Embodiments 1 and 2, and thus description thereof will be omitted.

### <Additional Authorization Credential Acquisition Processing>

This processing is the same as in Embodiments 1 and 2, and thus description thereof will be omitted.

### Embodiment 4

In Embodiments 1 to 3, a single information processing terminal such as a smartphone manages credentials, detects abnormalities in biometric information, and sends requests to use the service. The present embodiment discloses a method in which abnormalities in biometric information are detected by a wearable device or the like, which is an information processing terminal other than the information processing terminal that manages credentials.

### <System Configuration>

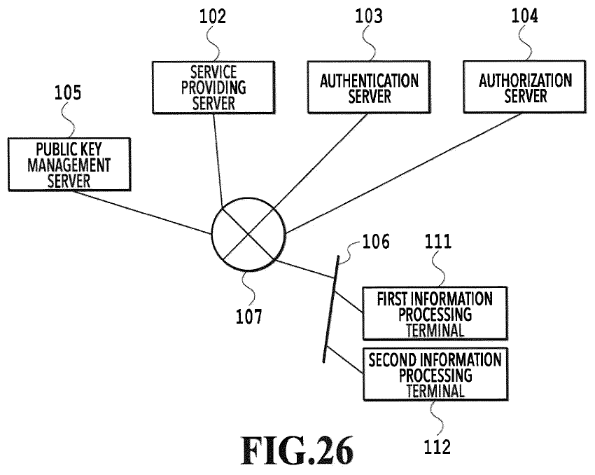

FIG. 26 is a configuration diagram of an information processing system in Embodiment 4. A service providing server 102, an authentication server 103, an authorization server 104, a public key management server 105, a local network 106, and a global network 107 are the same as those in Embodiments 1 to 3, and thus description thereof will be omitted.

A first information processing terminal 111 is an information processing terminal such as a smartphone. The information processing terminal 111 has a function of requesting a service provided by the service providing server 102. The information processing terminal 111 also has an authentication function and an authorization function for authenticating a user, and supports authentication processing, authorization processing, and the like for the service providing server 102. In addition, the information processing terminal 111 has a function of managing credentials for personal information such as a health insurance card. Furthermore, the information processing terminal 111 has a function of detecting information indicating a health anomaly sent from a second information processing terminal 112 which will be described later.

The second information processing terminal 112 is an information processing terminal such as a wearable device or a smartphone. The second information processing terminal has a function of managing biometric information of the user, detecting poor physical condition, and sending such information to the first information processing terminal.

### <Hardware Configuration>

Hardware configurations of the service providing server 102, the authentication server 103, the authorization server 104, and the public key management server 105 are the same as those in Embodiment 3, and thus description thereof will be omitted. Also, the first information processing terminal 111 and the second information processing terminal 112 have the same hardware configuration as that of the information processing terminal 101 in Embodiment 3, and thus description thereof will be omitted.

### <Module Configuration>

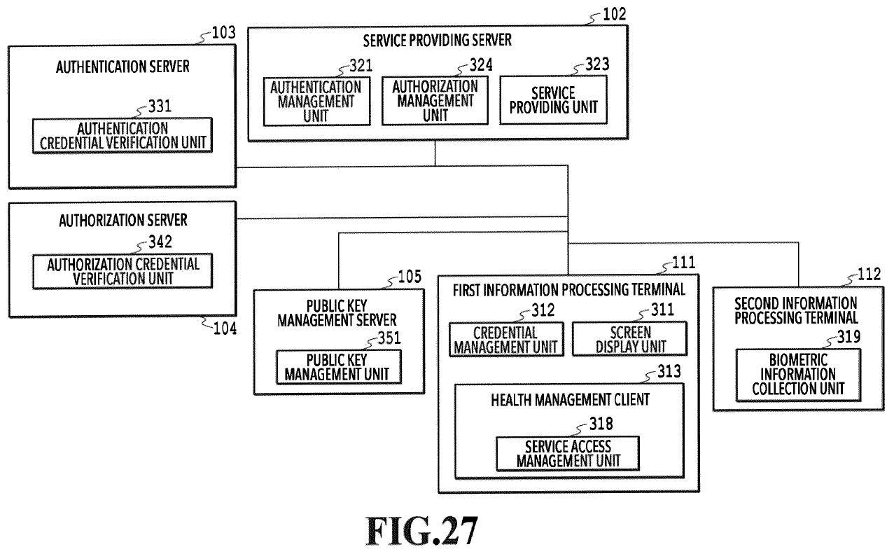

FIG. 27 is a module configuration diagram of each apparatus according to Embodiment 4.

Since a screen display unit 311 and a credential management unit 312 of the first information processing terminal 111 are the same as those of the information processing terminal 101 in Embodiment 3, description thereof will be omitted. A service access management unit 318 of a health management client 313 has any one of the functions of the service access management units 315 to 317 in Embodiments 1 to 3. Furthermore, the service access management unit 318 has a function of performing processing to determine whether to obtain each credential, based on alarm information sent by the second information processing terminal 112. In the present embodiment, the service access management unit 318 determines whether to obtain the credential, based on the alarm information sent by the second information processing terminal 112. On the other hand, the service access management unit 318 may be configured to manage a threshold information table held by the biometric information management unit 314 in Embodiments 1 to 3, and to determine whether the threshold value is exceeded.

The second information processing terminal 112 has a biometric information collection unit 319. The biometric information collection unit 319 has a function of sending alarm information to the first information processing terminal 111, in addition to the function of the biometric information management unit 314 in Embodiments 1 to 3. The alarm information in the present Embodiment Is the same as the alarm information in Embodiments 1 to 3. In the present embodiment, the biometric information collection unit 319 is configured to send the alarm information only in a case where a threshold value is exceeded, but the configuration may be such that the biometric information collection unit 319 sends the alarm information to the first information processing terminal 111 upon collection of the biometric information, and the first information processing terminal 111 determines whether the threshold value is exceeded.

The configurations of the service providing server 102, the authentication server 103, the authorization server 104, and the public key management server 105 are the same as those in Embodiments 1 to 3, and thus description thereof will be omitted.

### <Credential Selection Processing>

This processing is the same as in Embodiments 1 to 3, and thus description thereof will be omitted.

### <Additional Credential Selection Processing>

This processing is the same as in Embodiments 1 to 3, and thus description thereof will be omitted.

### <Emergency Service Access Processing>

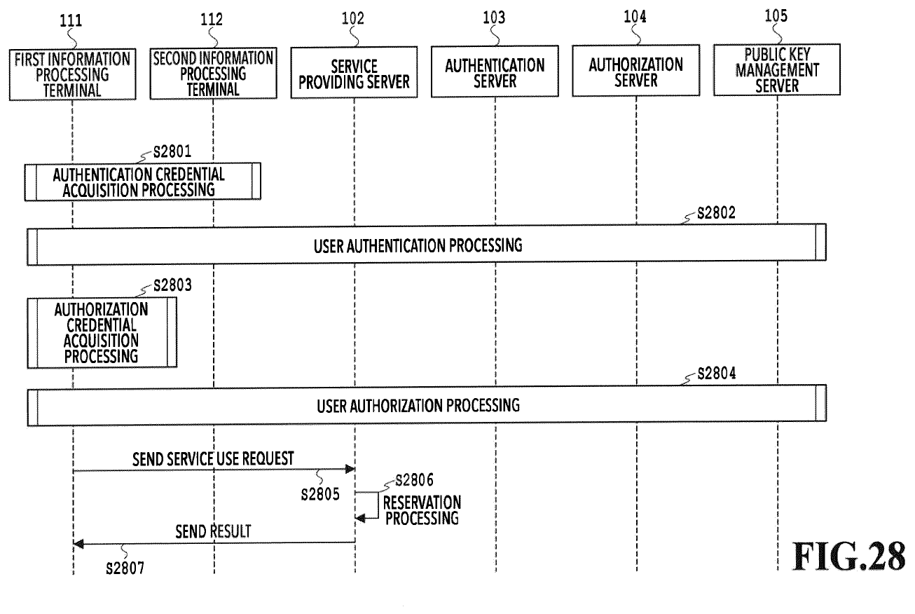

FIG. 28 is a sequence diagram for explaining emergency service access processing according to Embodiment 4. In addition to the emergency service access processing in Embodiments 1 to 3, processing of emergency service access determination between the first information processing terminal 111 and the second information processing terminal 112 is disclosed. FIG. 28 illustrates a sequence in the first information processing terminal 111, the second information processing terminal 112, the service providing server 102, the authentication server 103, the authorization server 104, and the public key management server 105.

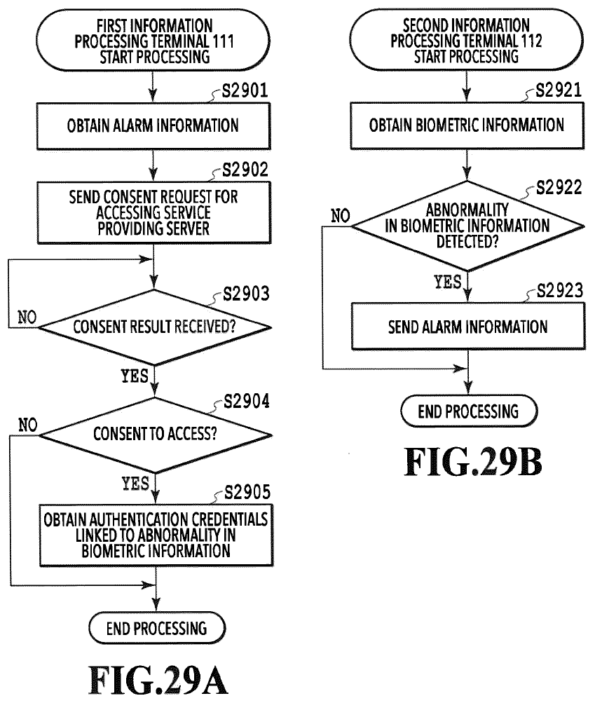

As this processing starts, in S2801, authentication credential acquisition processing is executed. The authentication credential acquisition processing will be described in detail later with reference to FIGS. 29A and 29B.

S2802 to S2807 are the same as S602 to S607 in Embodiments 1 to 3, and thus description thereof will be omitted.

### <Authentication Credential Acquisition Processing>

FIGS. 29A and 29B are flowcharts for explaining the authentication credential acquisition processing according to the present embodiment. In this processing, the first information processing terminal 111 determines whether to obtain authentication credentials, by acquiring biometric information of the user who uses the second information processing terminal 112. FIGS. 29A and 29B are flowcharts illustrating processing performed by the first information processing terminal 111 and the second information processing terminal 112 in the authentication credential acquisition processing.

FIG. 29A is a flowchart for explaining the authentication credential acquisition processing performed by the first information processing terminal 111. As this processing starts, in S2901, the service access management unit 318 of the first information processing terminal 111 receives alarm information from the second information processing terminal 112.

S2902 to S2905 are the same as S703 to S706 in Embodiments 1 to 3, and thus description thereof will be omitted.

FIG. 29B is a flowchart for explaining the authentication credential acquisition processing performed by the second information processing terminal 112. S2921 to S2922 in this processing are the same as S701 to S702 in Embodiment 3, and thus description thereof will be omitted.

In S2923, the biometric information collection unit 319 of the second information processing terminal 112 sends alarm information to the first information processing terminal 111, and ends this processing.

### <User Authentication Processing>

This processing is the same as in Embodiments 1 to 3, and thus description thereof will be omitted.

### <Authorization Credential Acquisition Processing>

This processing is the same as in Embodiments 1 to 3, and thus description thereof will be omitted.

### <User Authorization Processing>

This processing is the same as in Embodiments 1 to 3, and thus description thereof will be omitted.

### <Additional Authorization Credential Acquisition Processing>

This processing is the same as in Embodiments 1 to 3, and thus description thereof will be omitted.

### Embodiment 5

In Embodiment 4, the biometric information abnormality detection is performed by an information processing terminal such as a wearable device. The present embodiment discloses a method in which an information processing terminal such as a wearable device makes a service use request, in addition to detecting abnormality in biometric information, and another information processing terminal such as a smartphone manages credentials.

### <System Configuration>

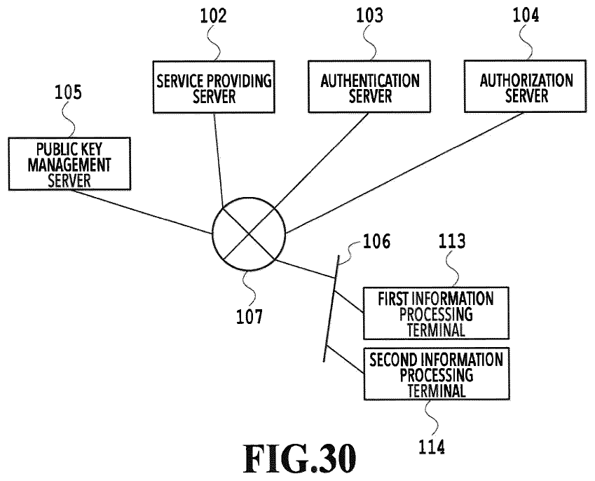

FIG. 30 is a configuration diagram of an information processing system according to Embodiment 5. A service providing server 102, an authentication server 103, an authorization server 104, a public key management server 105, a local network 106, and a global network 107 are the same as those in Embodiments 1 to 4, and thus description thereof will be omitted.

A first information processing terminal 113 is an information processing terminal such as a wearable device. The information processing terminal 113 has a function of requesting a service provided by the service providing server 102. The information processing terminal 113 also has an authentication function and an authorization function for authenticating a user, and supports authentication processing, authorization processing, and the like for the service providing server 102. The first information processing terminal 113 has a function of managing biometric information of the user, detecting poor physical condition, and sending such information to a second information processing terminal 114 which will be described later.

The second information processing terminal 114 is an information processing terminal such as a wearable device or a smartphone. The second information processing terminal 114 has a function of managing credentials for personal information such as a health insurance card. The second information processing terminal 114 also has a function of sending credentials upon request from the first information processing terminal 113.

### <Hardware Configuration>

A hardware configuration of the present Embodiment Is the same as in Embodiments 1 to 4, and thus description thereof will be omitted. A hardware the description will be omitted.

### <Module Configuration>

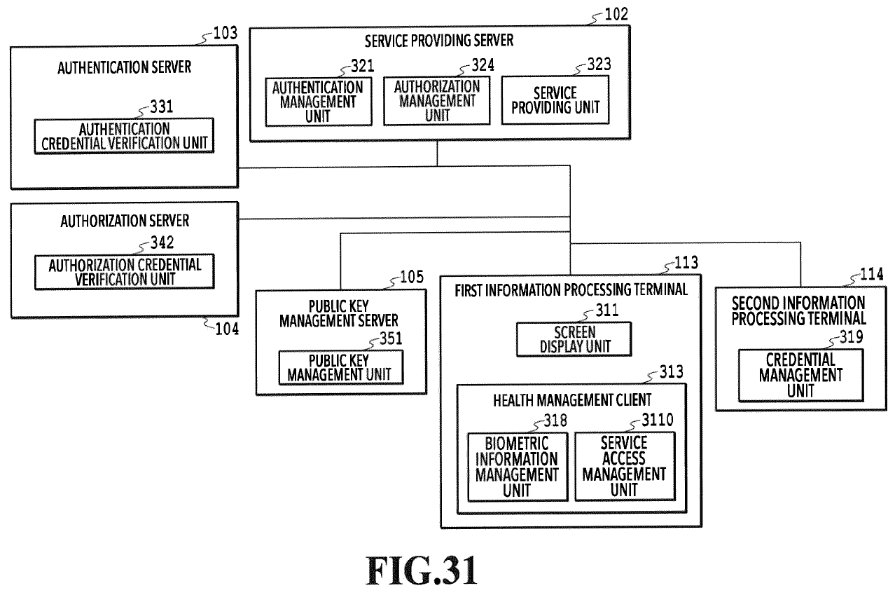

FIG. 31 is a module configuration diagram of each apparatus according to Embodiment 5.

Since a screen display unit 311, a credential management unit 312, and a biometric information management unit 314 of the first information processing terminal 113 are the same as those of the information processing terminal 101 in Embodiments 1 to 4, description thereof will be omitted. A service access management unit 3110 of a health management client 313 has any one of the functions of the service access management units 315 to 318 in Embodiments 1 to 4. Furthermore, the service access management unit 3110 has a function of sending a request to the second information processing terminal 114 to obtain credentials upon receipt of alarm information from the biometric information management unit 314.

The second information processing terminal 114 has a credential management unit 3111. The credential management unit 3111 has a function of receiving a credential acquisition request sent from the first information processing terminal 113 and sending the requested credentials, in addition to the functions of the credential management unit 312 in Embodiments 1 to 4.

The configurations of the service providing server 102, the authentication server 103, the authorization server 104, and the public key management server 105 are the same as those in Embodiment 3, and thus description thereof will be omitted.

### <Credential Selection Processing>

This processing is the same as in Embodiments 1 to 4, and thus description thereof will be omitted.

### <Additional Credential Selection Processing>

This processing is the same as in Embodiments 1 to 4, and thus description thereof will be omitted.

### <Emergency Service Access Processing>

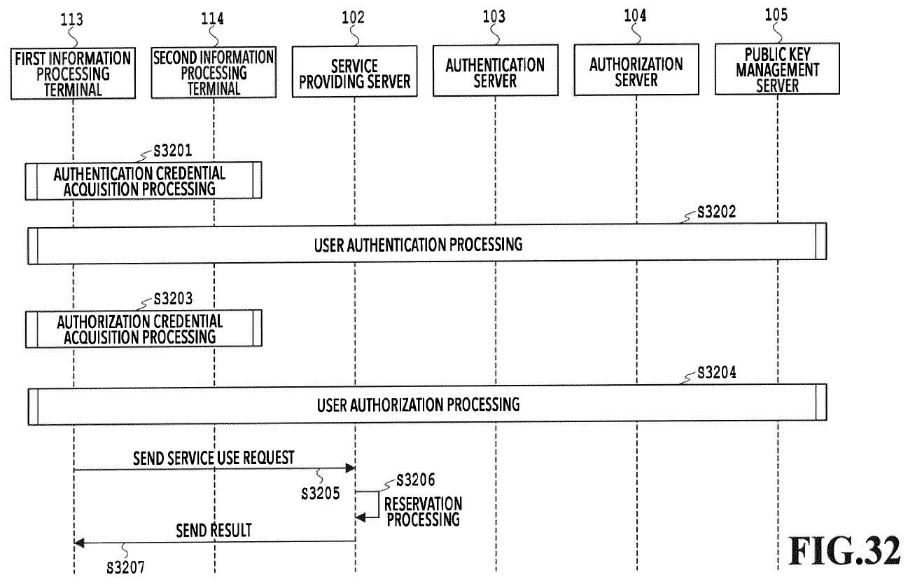

FIG. 32 is a sequence diagram for explaining emergency service access processing according to Embodiment 5. In addition to the emergency service access processing in Embodiment 3, processing of emergency service access determination between the first information processing terminal 113 and the second information processing terminal 114 is disclosed. FIG. 32 illustrates a sequence in the first information processing terminal 113, the second information processing terminal 114, the service providing server 102, the authentication server 103, the authorization server 104, and the public key management server 105.

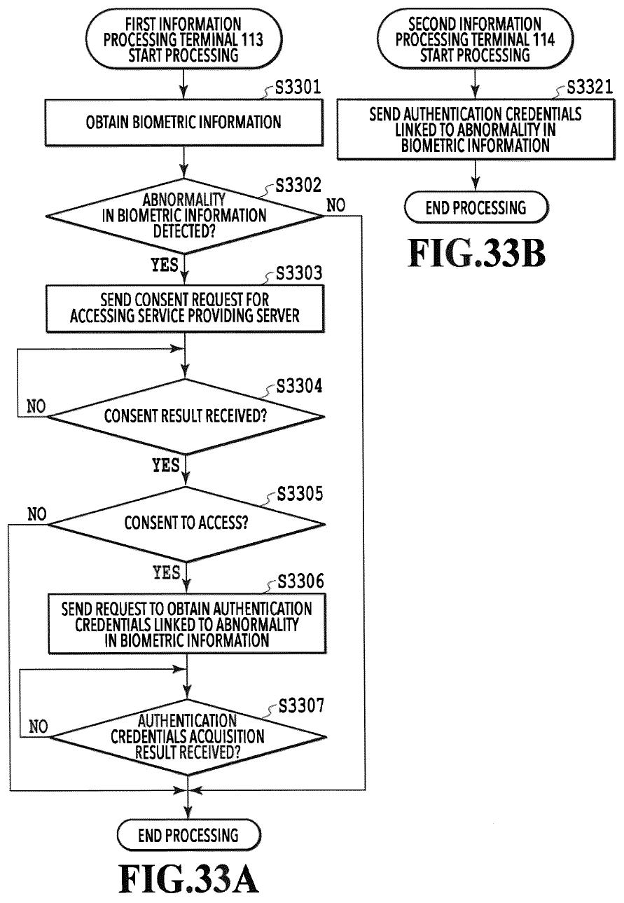

As this processing starts, in S3201, authentication credential acquisition processing is executed. The authentication credential acquisition processing will be described in detail later with reference to FIGS. 33A and 33B.

S3202 is the same as S2802 in Embodiment 4, and thus description thereof will be omitted.

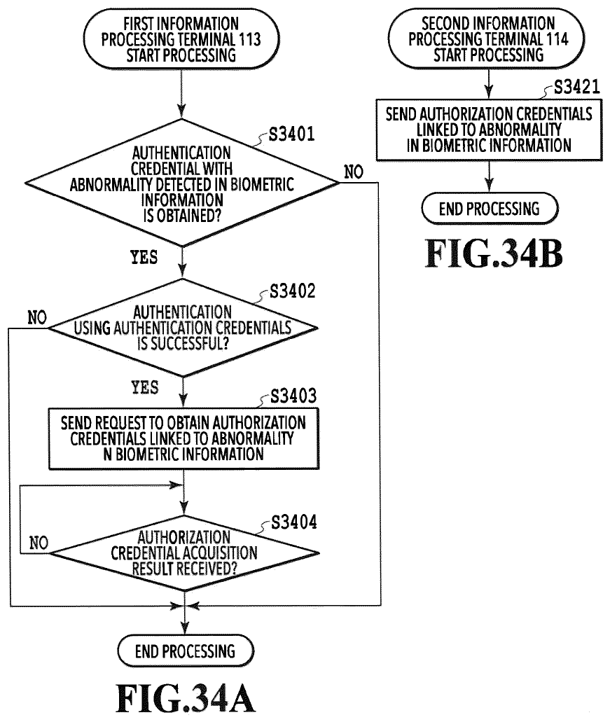

In S3203, authorization credential acquisition processing is executed. The authorization credential acquisition processing will be described later with reference to FIGS. 34A and 34B.

S3204 to S3207 are the same as S2804 to S2807 in Embodiment 4, and thus description thereof will be omitted.

### <Authentication Credential Acquisition Processing>

FIGS. 33A and 33B are flowcharts for explaining the authentication credential acquisition processing according to Embodiment 5. In this processing, the first information processing terminal 113 determines whether to obtain authentication credentials, by acquiring biometric information of the user who uses the first information processing terminal 113. In a case where the first information processing terminal 113 obtains authentication credentials, the first information processing terminal 113 obtains the authentication credentials from the second information processing terminal 114.

FIG. 33A is a flowchart for explaining the authentication credential acquisition processing performed by the first information processing terminal 113. S3301 to S3305 are the same as S701 to S705 in Embodiments 1 to 3, and thus description thereof will be omitted.

In S3306, the service access management unit 3110 of the first information processing terminal 113 sends a request to the second information processing terminal 114 to obtain authentication credentials.

In S3307, the service access management unit 3110 of the first information processing terminal 113 verifies whether authentication credentials are obtained from the second information processing terminal 114. If the authentication credentials are obtained, this processing ends, and if not, S3307 is repeatedly executed at predetermined intervals until authentication credentials are obtained.

FIG. 33B is a flowchart for explaining the authentication credential acquisition processing performed by the second information processing terminal 114. As this processing starts, in S3321, the credential management unit 3111 of the second information processing terminal 114 sends the authentication credentials requested by the first information processing terminal 113, and ends this processing.

### <User Authentication Processing>

This processing is the same as in Embodiments 1 to 4, and thus description thereof will be omitted.

### <Authorization Credential Acquisition Processing>

FIGS. 34A and 34B are flowcharts for explaining the authorization credential acquisition processing according to Embodiment 5. In this processing, the first information processing terminal 113 determines whether to obtain authorization credentials, by acquiring biometric information of the user who uses the first information processing terminal 113. In a case of acquiring the authorization credentials, the first information processing terminal 113 obtains the authorization credential from the second information processing terminal 114.

FIG. 34A is a flowchart for explaining the authorization credential acquisition processing performed by the first information processing terminal 113. S3401 to S3402 are the same as S904 to S905 in Embodiment 3, and thus description thereof will be omitted.

In S3403, the service access management unit 3110 of the first information processing terminal 113 sends a request to the second information processing terminal 114 to obtain authorization credentials based on an abnormality in the biometric information.

In S3404, the service access management unit 3110 of the first information processing terminal 113 determines whether the authorization credentials are obtained from the second information processing terminal 114. If the authorization credentials are obtained, this processing ends, and if not, S3404 is repeatedly executed at predetermined intervals until the authorization credentials are obtained.

FIG. 34B is a flowchart for explaining the authorization credential acquisition processing performed by the second information processing terminal 114. As this processing starts, in S3421, the credential management unit 3111 of the second information processing terminal 114 sends the authorization credentials requested by the first information processing terminal 113, and ends this processing.

### <User Authorization Processing>

This processing is the same as in Embodiments 1 to 4, and thus description thereof will be omitted.

### <Additional Authorization Credential Acquisition Processing>

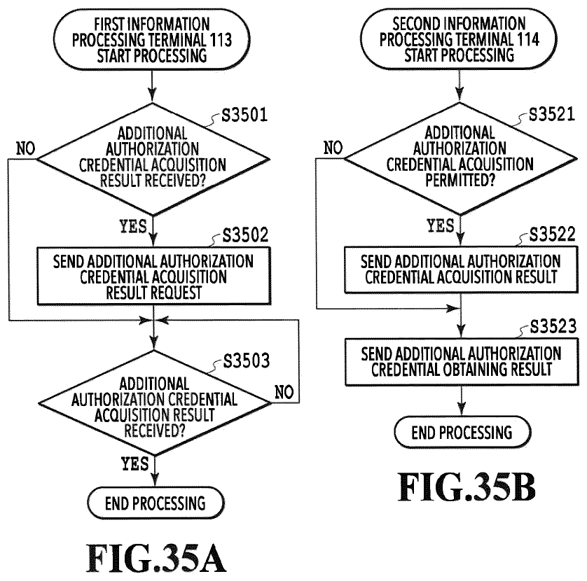

FIGS. 35A and 35B are flowcharts for explaining additional authorization credential acquisition processing according to the present embodiment. In this processing, the first information processing terminal 113 additionally obtains public credentials, in response to a request to obtain additional authorization credentials from the authorization server 104. In a case of acquiring additional authorization credentials, the first information processing terminal 113 obtains authorization credentials from the second information processing terminal 114.

FIG. 35A is a flowchart for explaining the additional authorization credential acquisition processing performed by the first information processing terminal 113. S3501 is the same as S1901 in Embodiment 4, and thus description thereof will be omitted.

In S3502, the service access management unit 3110 sends a request to the second information processing terminal 114 to obtain additional credentials corresponding to a credential identifier.

In S3503, the service access management unit 3110 verifies whether the additional authorization credentials are obtained from the second information processing terminal 114. If the additional authorization credentials are obtained, this processing ends, and if not, S3503 is repeatedly executed at predetermined intervals until the additional authorization credentials are obtained.

FIG. 35B is a flowchart for explaining the additional authorization credential acquisition processing performed by the second information processing terminal 114. S3521 is the same as S1902 in Embodiment 4, and thus description thereof will be omitted.

In S3522, the credential management unit 3111 obtains the authorization credentials requested by the first information processing terminal 113.

In S3523, the credential management unit 3111 sends the authorization credentials requested by the first information processing terminal 113, and ends this processing.

### Embodiment 6

In Embodiments 4 and 5, the biometric information abnormality detection is performed by the information processing terminal such as a wearable device. The present embodiment discloses a method in which biometric information is managed by an external server, and credentials are obtained and a request for access to a service is made based on a notification of a biometric abnormality sent from the external server.

### <System Configuration>

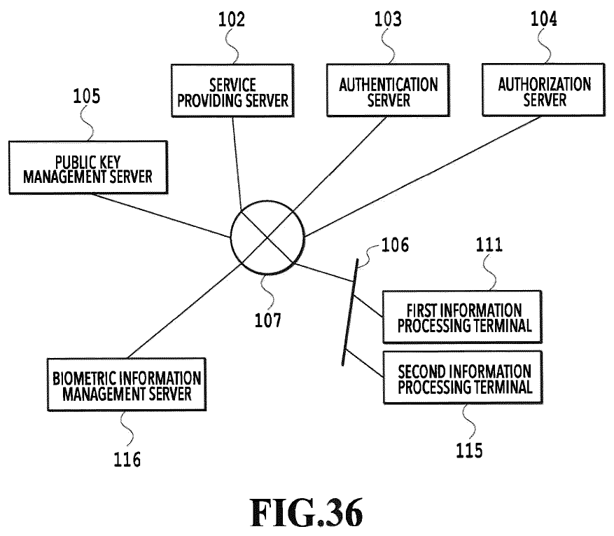

FIG. 36 is a configuration diagram of an information processing system according to an embodiment of the present invention. A first information processing terminal 111, a service providing server 102, an authentication server 103, an authorization server 104, a public key management server 105, a local network 106, and a global network 107 are the same as those in Embodiments 1 to 5, and thus description thereof will be omitted.

A second information processing terminal 115 is an information processing terminal such as a wearable device or a smartphone. The second information processing terminal 115 obtains biometric information of the user and sends the biometric information to a biometric information management server 116. The second information processing terminal 115 also sends alarm information to the first information processing terminal 111, based on a biometric abnormality notification sent from the biometric information management server 116.

The biometric information management server 116 manages the biometric information of the user. The biometric information management server 116 determines the biometric abnormality based on the biometric information sent from the second information processing terminal 115, and sends an abnormality notification to the biometric information management server 116.

### <Hardware Configuration>

Hardware configurations of the first information processing terminal 111, the second information processing terminal 115, the service providing server 102, the authentication server 103, the authorization server 104, and the public key management server 105 are the same as those in Embodiments 1 to 5, and thus description thereof will be omitted.

### <Module Configuration>

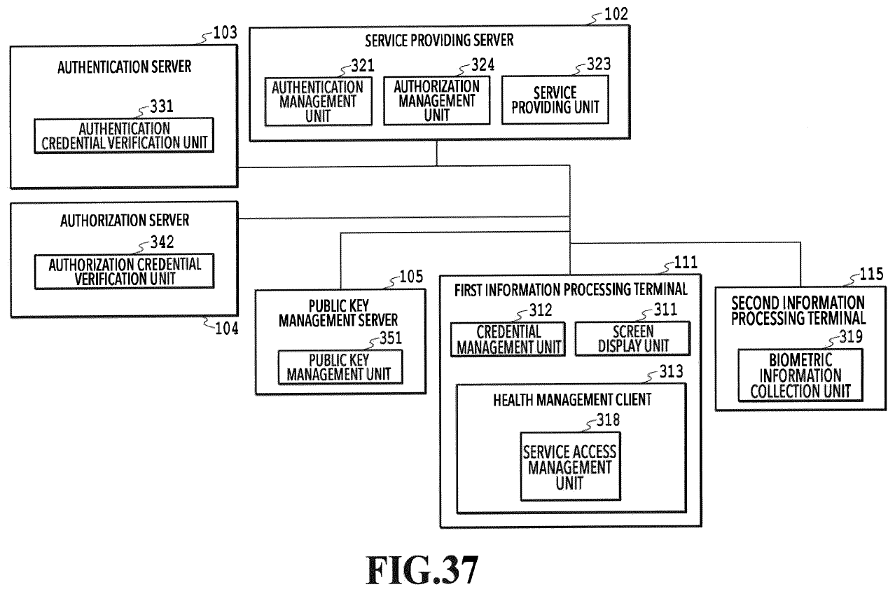

FIG. 37 is a module configuration diagram of each apparatus according to Embodiment 6.

The second information processing terminal 115 includes a biometric information collection unit 3112. The biometric information collection unit 3112 has a function of sending biometric information to the biometric information management server 116, in addition to the function of the biometric information collection unit 319 in Embodiment 4. An example of the biometric information sent to the biometric information management server 116 by the biometric information collection unit 3112 in the present embodiment will be described below. The biometric information includes at least a category indicating the type of biometric information that exceeds a threshold value, and an observation value indicating a collected value. The alarm information is in JSON (JavaScript Object Notation) format in the present embodiment, but may be in another data format.

### (Example of Biometric Information)

{“Category”:“Core body temperature”, “Observation value”:39.5}

Upon receipt of biometric abnormality information, which Is a message indicating a biometric abnormality sent from the biometric information management server 116, the biometric information collection unit 3112 sends alarm information to the first information processing terminal 111.

The biometric information management server 116 includes a biometric information management unit 3113. The biometric information management unit 3113 manages a threshold information table for managing threshold values of biometric information. The threshold information is the same as in Embodiments 1 to 5. The biometric information sent from the second information processing terminal 115 is compared with the value of the threshold information corresponding to the category of the sent biometric information, and if the threshold value is exceeded, biometric abnormality information, which is a notification of biometric abnormality, is sent to the second information processing terminal 115. An example of the biometric abnormality information in the present embodiment will be described below. The biometric abnormality information includes at least a category indicating the type of biometric information that exceeds the threshold value. The alarm information is in JSON (JavaScript Object Notation) format in the present embodiment, but may be in another data format.

### (Example of Biometric Abnormality Information)

{“Category”:“Core body temperature”}

The configurations of the first information processing terminal 111, the service providing server 102, the authentication server 103, the authorization server 104, and the public key management server 105 are the same as those in Embodiments 1 to 5, and thus description thereof will be omitted.

### <Credential Selection Processing>

This processing is the same as in Embodiments 1 to 5, and thus description thereof will be omitted.

### <Additional Credential Selection Processing>

This processing is the same as in Embodiments 1 to 5, and thus description thereof will be omitted.

### <Emergency Service Access Processing>

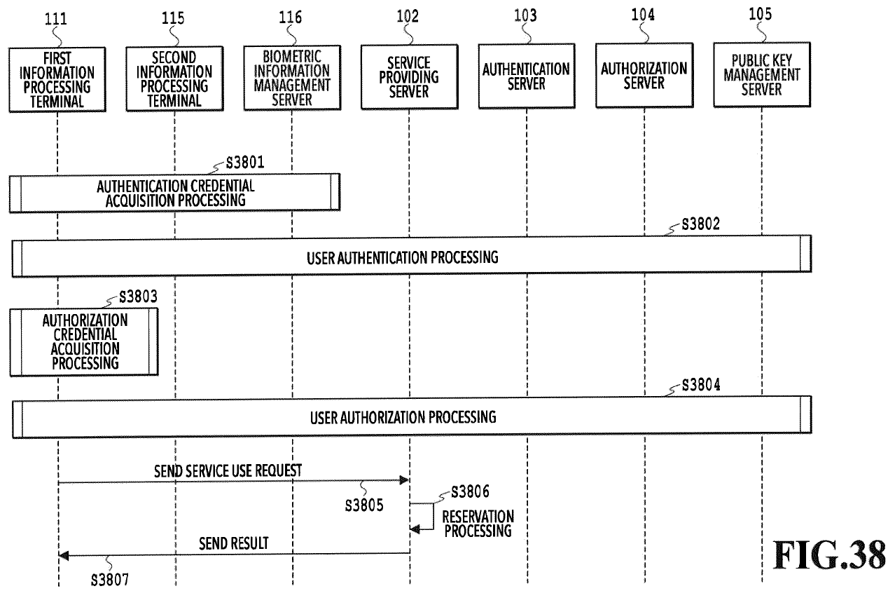

FIG. 38 is a sequence diagram for explaining emergency service access processing according to Embodiment 6. In addition to the emergency service access processing in Embodiment 4, processing of emergency service access determination between the first information processing terminal 111, the second information processing terminal 115, and the biometric information management server 116 is disclosed. FIG. 38 illustrates a sequence in the first information processing terminal 111, the second information processing terminal 115, the service providing server 102, the authentication server 103, the authorization server 104, the public key management server 105, and the biometric information management server 116.

In S3801, authentication credential acquisition processing is executed. The authentication credential acquisition processing will be described later.

S3802 to S3807 are the same as S2802 to S2807 in Embodiment 4, and thus description thereof will be omitted.

### <Authentication Credential Acquisition Processing>

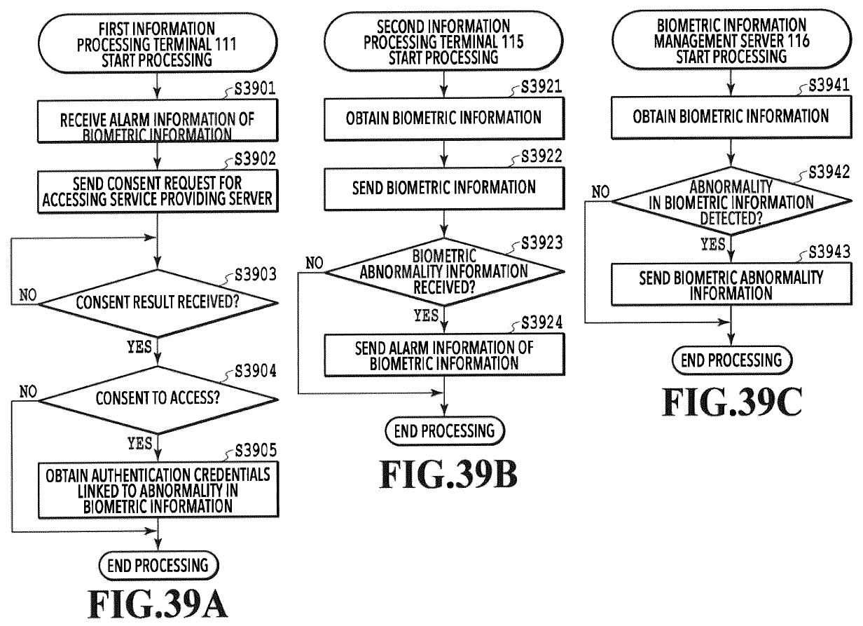

FIGS. 39A to 39C are flowcharts for explaining the authentication credential acquisition processing according to the present embodiment. In this processing, biometric information of the user who uses the first information processing terminal 111 is obtained and sent to the biometric information management server 116, and then it is determined whether to obtain authentication credentials, based on the biometric abnormality information sent by the biometric information management server 116. FIGS. 39A to 39C are flowcharts illustrating processing performed by the first information processing terminal 111, the second information processing terminal 115, and the biometric information management server 116 in the authentication credential acquisition processing.

FIG. 39A is a flowchart for explaining the authentication credential acquisition processing performed by the first information processing terminal 111. S3901 to S3905 are the same as S2901 to S2905 in Embodiment 4, and thus description thereof will be omitted.

FIG. 39B is a flowchart for explaining the authentication credential acquisition processing performed by the second information processing terminal 115.

In S3921, the biometric information collection unit 3112 obtains biometric information of the user.

In S3922, the biometric information collection unit 3112 sends the biometric information to the biometric information management server 116.

In S3923, the biometric information collection unit 3112 verifies whether biometric abnormality information is received from the biometric information management server 116. If the information is obtained, the processing proceeds to S3924, and if not, this processing ends.

In S3924, the biometric information collection unit 3112 sends alarm information linked to the obtained biometric information to the first information processing terminal 111, and ends this processing. The category of the alarm information corresponds to the category of the biometric information, and the value of the alarm information corresponds to the value of the biometric information.

FIG. 39C is a flowchart for explaining the authentication credential acquisition processing performed by the biometric information management server 116.

In S3941, the biometric information management unit 3113 obtains the biometric information received from the second information processing terminal 115.

In S3942, the biometric information management unit 3113 checks whether the biometric information exceeds a threshold value. If the threshold value is exceeded, the processing proceeds to S3943, and if not, this processing ends.

In S3943, the biometric information management unit 3113 sends the biometric abnormality information to the second information processing terminal 115, and ends this processing. The category of the biometric abnormality information corresponds to the category of the biometric information that exceeds the threshold value.

### <User Authentication Processing>

This processing is the same as in Embodiments 1 to 5, and thus description thereof will be omitted.

### <Authorization Credential Acquisition Processing>

This processing is the same as in Embodiments 1 to 5, and thus description thereof will be omitted.

### <User Authorization Processing>

This processing is the same as in Embodiments 1 to 5, and thus description thereof will be omitted.

### <Additional Authorization Credential Acquisition Processing>

This processing is the same as in Embodiments 1 to 5, and thus description thereof will be omitted.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure makes it possible to automatically read data that requires user authentication processing based on the biometric information of the user.

This application claims the benefit of Japanese Patent Application No. 2024-169204, filed Sep. 27, 2024, which is hereby incorporated by reference herein in its entirety.

What is claimed is:

1. An information processing apparatus comprising:
at least one memory and at least one processor which function as:
an obtaining unit configured to obtain biometric information of a user;
a management unit configured to manage permission to read data stored in a predetermined storage unit and used for the user to use a cloud service, through first authentication processing for authenticating the user based on user input; and
a reading unit configured to read the permitted data from the predetermined storage unit, wherein
the management unit permits reading of data from the predetermined storage unit without performing the first authentication processing if the biometric information satisfies a predetermined condition.

2. The information processing apparatus according to claim 1, wherein
the predetermined condition is that an observation value of the biometric information exceeds a predetermined threshold value.

3. The information processing apparatus according to claim 1, wherein
the data stored in the predetermined storage unit includes credentials of the user to be used in second authentication processing for authenticating the user or authorization processing for granting predetermined authority to the user in a first external apparatus configured to provide a cloud service.

4. The information processing apparatus according to claim 3, wherein
the management unit permits reading of a predetermined credential for each type of the biometric information.

5. The information processing apparatus according to claim 3, wherein
upon receipt of a request to add the credential, the management unit permits reading of the credential requested to be added, and
the reading unit reads the credential requested to be added, which is permitted to be read by the management unit.

6. The information processing apparatus according to claim 3, wherein
the second authentication processing or the authorization processing 1s processing of making a medical appointment at a medical office.

7. The information processing apparatus according to claim 1, wherein
the predetermined storage unit is a storage device provided in the information processing apparatus.

8. The information processing apparatus according to claim 1, wherein
the obtaining unit includes an observation unit configured to observe the biometric information of the user, and obtains the biometric information from the observation unit.

9. The information processing apparatus according to claim 1, wherein
the obtaining unit obtains the biometric information of the user from an observation unit configured to observe the biometric information.

10. The information processing apparatus according to claim 9, wherein
the reading unit is a second external apparatus including the observation unit, and sends data read from the predetermined storage unit to the second external apparatus which makes a request to use the cloud service.

11. The information processing apparatus according to claim 1, wherein
the obtaining unit obtains the biometric information from a third external apparatus configured to manage the biometric information.

12. The information processing apparatus according to claim 11, wherein
the obtaining unit obtains only the biometric information that satisfies the predetermined condition from the third external apparatus.

13. The information processing apparatus according to claim 11, wherein
the management unit receives from the third external apparatus that the biometric information satisfies the predetermined condition.

14. The information processing apparatus according to claim 1, wherein
the biometric information is at least one of a fingerprint, vein, voiceprint, iris, facial image, body temperature, core body temperature, and heart rate.

15. An information processing system including an information processing terminal for managing credentials to be used for a user to use a cloud service and a service providing server for providing the cloud service, wherein
the information processing terminal includes
at least one memory and at least one processor which function as:
an obtaining unit configured to obtain biometric information of a user;
a management unit configured to manage permission to read data stored in a predetermined storage unit and used for the user to use a cloud service, through first authentication processing for authenticating the user based on user input; and
a reading unit configured to read the permitted data from the predetermined storage unit,
the management unit permits reading of data from the predetermined storage unit without performing the first authentication processing if the biometric information satisfies a predetermined condition, and
the service providing server performs authentication processing and authorization processing based on the credentials sent by the information processing terminal, and provides the cloud service to the information processing terminal if the authentication processing and the authorization processing are successful.

16. An information processing method comprising:
obtaining biometric information of a user;
managing permission to read data stored in a predetermined storage unit and used for the user to use a cloud service, through first authentication processing for authenticating the user based on user input; and
reading the permitted data from the predetermined storage unit, wherein
the managing includes permitting reading of data from the predetermined storage unit without performing the first authentication processing if the biometric information satisfies a predetermined condition.

17. A non-transitory computer readable storage medium storing a program for causing a computer to perform an information processing method comprising:
obtaining biometric information of a user;
managing permission to read data stored in a predetermined storage unit and used for the user to use a cloud service, through first authentication processing for authenticating the user based on user input; and
reading the permitted data from the predetermined storage unit, wherein
the managing includes permitting reading of data from the predetermined storage unit without performing the first authentication processing if the biometric information satisfies a predetermined condition.
